(19) United States
(12) Patent Application Publication
(10) Pub. No.: US 2015/0302803 A1
(43) Pub. Date: Oct. 22, 2015

(54) DISPLAY DEVICE, METHOD OF DRIVING DISPLAY DEVICE, AND SIGNAL OUTPUT CIRCUIT

(71) Applicant: Sony Corporation, Tokyo (JP)

(72) Inventors: Takeshi Aoki, Kanagawa (JP); Iwao Ushinohama, Kanagawa (JP)

(21) Appl. No.: 14/441,046

(22) PCT Filed: Nov. 8, 2013
(86) PCT No.: PCT/JP2013/080272

§ 371 Date: May 6, 2015

(30) Foreign Application Priority Data
Nov. 13, 2012 (JP) 2012-249073
Apr. 3, 2013 (JP) 2013-077482

(51) Int. Cl. G09G 3/32

(52) U.S. Cl. CPC G09G 3/3291; G09G 3/3283; G09G 2330/021

(57) ABSTRACT

A signal output circuit that alternately supplies a reference voltage and a video signal voltage to a data line includes:
an output node to which the data line is connected;
a reference voltage node to which the reference voltage is applied;
a source amplifier that outputs the video signal voltage in accordance with an input gradation signal;
a first switch provided between the output side of the source amplifier and the output node;
a second switch provided between the reference voltage node and the output node; and
a third switch provided in the power supply path of the source amplifier,
wherein, during a scanning period for scanning display elements row by row, switching is performed between a state where the first switch is non-conductive while the second switch is conductive and a state where the first switch is conductive while the second switch is non-conductive, and
the third switch is put into a conductive state when the first switch is put into a conductive state, and is put into a non-conductive state when the first switch is put into a non-conductive state.

### TECHNICAL FIELD

The present disclosure relates to a display device, a method of driving the display device, and a signal output circuit.

### BACKGROUND ART

Display elements including light emitting units, and display devices including such display elements are well known. For example, display elements including organic electroluminescence light emitting units (hereinafter also referred to simply as organic EL display elements) that utilize electroluminescence (hereinafter also referred to simply as EL) of an organic material are drawing attention as display elements that can realize high-luminance light emission through low-voltage DC driving.

Like the drive systems for liquid crystal display devices, the known drive systems for display devices including organic EL display elements are the simple matrix system and the active matrix system. The active matrix system has the drawback that the structure becomes complicated, but has the advantage that images with higher luminance can be obtained, for example. An organic EL display element that is driven by the active matrix system includes not only a light emitting unit formed with an organic layer and the like including a light emitting layer, but also a drive circuit for driving the light emitting unit.

As a circuit for driving an organic electroluminescence light emitting unit (hereinafter also referred to simply as the light emitting unit), a drive circuit that includes two transistors and one capacitance unit (called a 2Tr/1C drive circuit) is known from JP 2007-310311 A (Patent Document 1) and the like. As shown in FIG. 2, which will be described later, a 2Tr/1C drive circuit includes the two transistors of a write transistor TR_{W} and a drive transistor TR_{D}, and a capacitance unit C₁.

### CITATION LIST

### Patent Document

Patent Document 1: JP 2007-310311 A

### SUMMARY OF THE INVENTION

### Problems to be Solved by the Invention

So as to properly operate the above described display device including display elements, it is necessary to alternately supply a reference voltage and a video signal voltage from a signal output circuit to the data line connected to the write transistor (see FIGS. 4A, 4D, and 4F of Patent Document 1). Generally, a signal output circuit designed to alternately supply a reference voltage and a video signal voltage tends to consume a larger amount of power, compared with a signal output circuit designed to supply only video signal voltages. So as to reduce the power consumption by a display device, a signal output circuit designed to alternately supply a reference voltage and a video signal voltage is expected to reduce its power consumption.

Therefore, the present disclosure aims to provide a signal output circuit that can reduce power consumption, a display device including the signal output circuit, and a method of driving the display device.

### Solutions to Problems

To achieve the above objective, a display device of the present disclosure includes:

a display unit that includes display elements arranged in a two-dimensional matrix fashion, the display elements each including a light emitting unit of a current drive type and a drive circuit that drives the light emitting unit, the display elements being connected to a scanning line extending in a row direction and a data line extending in a column direction; and

a signal output circuit that alternately supplies a reference voltage and a video signal voltage to the data line,

wherein the signal output circuit includes:

an output node to which the data line is connected;

a reference voltage node to which the reference voltage is applied;

a source amplifier that outputs the video signal voltage in accordance with an input gradation signal;

a first switch provided between an output side of the source amplifier and the output node;

a second switch provided between the reference voltage node and the output node; and

a third switch provided in a power supply path of the source amplifier,

during a scanning period for scanning the display elements row by row, switching is performed between a state where the first switch is non-conductive while the second switch is conductive and a state where the first switch is conductive while the second switch is non-conductive, and

the third switch is put into a conductive state when the first switch is put into a conductive state, and is put into a non-conductive state when the first switch is put into a non-conductive state.

To achieve the above objective, a signal output circuit of the present disclosure is used to alternately supply a reference voltage and a video signal voltage to a data line of a display unit including display elements arranged in a two-dimensional matrix fashion, the display elements each including a light emitting unit of a current drive type and a drive circuit that drives the light emitting unit, the display elements being connected to a scanning line extending in a row direction and the data line extending in a column direction,

the signal output circuit including:

an output node to which the data line is connected;

a reference voltage node to which the reference voltage is applied;

a source amplifier that outputs the video signal voltage in accordance with an input gradation signal;

a first switch provided between an output side of the source amplifier and the output node;

a second switch provided between the reference voltage node and the output node; and

a third switch provided in a power supply path of the source amplifier,

wherein, during a scanning period for scanning the display elements row by row, switching is performed between a state where the first switch is conductive while the second switch is non-conductive and a state where the second switch is non-conductive while the second switch is conductive, and

the third switch is put into a conductive state when the first switch is put into a conductive state, and is put into a non-conductive state when the first switch is put into a non-conductive state.

To achieve the above objective, a method of the present disclosure for driving a display device including:

a display unit including display elements arranged in a two-dimensional matrix fashion, the display elements each including a light emitting unit of a current drive type and a drive circuit that drives the light emitting unit, the display elements being connected to a scanning line extending in a row direction and a data line extending in a column direction; and

a signal output circuit that alternately supplies a reference voltage and a video signal voltage to the data line,

the signal output circuit including:

an output node to which the data line is connected;

a reference voltage node to which the reference voltage is applied;

a source amplifier that outputs the video signal voltage in accordance with an input gradation signal;

a first switch provided between an output side of the source amplifier and the output node;

a second switch provided between the reference voltage node and the output node; and

a third switch provided in a power supply path of the source amplifier,

the method including:

during a scanning period for scanning the display elements row by row, performing switching between a state where the first switch is conductive while the second switch is non-conductive and a state where the second switch is non-conductive while the second switch is conductive, and

putting the third switch into a conductive state when the first switch is put into a conductive state, and putting the third switch into a non-conductive state when the first switch is put into a non-conductive state.

### Effects of the Invention

With a display device, a method of driving the display device, and a signal output circuit according to the present disclosure, it is possible to reduce power consumption in the signal output circuit that alternately supplies a reference voltage and a video signal voltage to data lines. Also, the allowance in terms of thermal design increases in the entire signal output circuit. Accordingly, higher integration of the semiconductor devices constituting the signal output circuit can also be achieved, and costs can be lowered.

### BRIEF DESCRIPTION OF DRAWINGS

FIG. 1 is a conceptual diagram of a display device according to a first embodiment.

FIG. 2 shows a schematic block diagram for explaining the structure of the part of a signal output circuit that contributes to driving of the nth data line, and a schematic circuit diagram for explaining the relations of connection of the (m, n)th display element with the signal output circuit, a scanning circuit, and a power supply unit.

FIG. 3 is a schematic circuit diagram for explaining an example structure of a source amplifier.

FIG. 4 is a schematic circuit diagram for explaining another example structure of a source amplifier.

FIG. 5 is a schematic circuit diagram for explaining yet another example structure of a source amplifier.

FIG. 6 is a schematic timing chart for explaining operation of the signal output circuit.

FIG. 7 is a schematic cross-sectional view of a part of the display unit including a display element.

FIG. 8 shows a schematic block diagram for explaining the structure of the part of a signal output circuit that contributes to driving of the nth data line, and a schematic circuit diagram for explaining the relations of connection of the (m, n)th display element with the signal output circuit, a scanning circuit, and a power supply unit.

FIG. 9 is a schematic circuit diagram for explaining an example structure of a source amplifier.

FIG. 10 is a schematic circuit diagram for explaining another example structure of a source amplifier.

FIG. 11 is a schematic circuit diagram for explaining yet another example structure of a source amplifier.

FIG. 12 is a schematic timing chart for explaining operation of the signal output circuit.

FIG. 13 is a table for explaining the structure of a look-up table for setting precharge voltage.

FIG. 14 is a table for explaining the structure of a look-up table for setting bias current.

FIG. 15 is a schematic block diagram for explaining the structure of a signal output circuit according to a third embodiment.

FIG. 16A is a schematic circuit diagram for explaining the connection between a timing controller and a differential reception unit as a reference example. FIG. 16B is a circuit diagram of the differential reception unit as the reference example.

FIG. 17A is a schematic circuit diagram for explaining the connection between a timing controller and a differential reception unit according to the third embodiment. FIG. 17B is a circuit diagram of the differential reception unit according to the third embodiment.

FIG. 18 is a schematic timing chart for explaining operation of a display device.

FIGS. 19A and 19B are diagrams schematically showing conductive/non-conductive states and the like of the respective transistors in the drive circuit of a display element.

FIGS. 20A and 20B are diagrams schematically showing conductive/non-conductive states and the like of the respective transistors in the drive circuit of a display element, continuing from FIG. 19B.

FIGS. 21A and 21B are diagrams schematically showing conductive/non-conductive states and the like of the respective transistors in the drive circuit of a display element, continuing from FIG. 20B.

FIGS. 22A and 22B are diagrams schematically showing conductive/non-conductive states and the like of the respective transistors in the drive circuit of a display element, continuing from FIG. 21B.

FIGS. 23A and 23B are diagrams schematically showing conductive/non-conductive states and the like of the respective transistors in the drive circuit of a display element, continuing from FIG. 22B.

FIG. 24 is a diagram schematically showing conductive/non-conductive states and the like of the respective transistors in the drive circuit of a display element, continuing from FIG. 23B.

FIG. 25 is a schematic circuit diagram for explaining another example of a drive circuit in a display device.

### MODES FOR CARRYING OUT THE INVENTION

The following is a description of the present disclosure based on embodiments, with reference to the drawings. The present disclosure is not limited to the embodiments, and various numerical values and materials used in the embodiments are examples. In the description below, like components or components having like functions are denoted by like reference numerals, and explanation of them will not be made more than once. Explanation will be made in the following order.

1. General description of a Display Device, a Method of Driving the Display Device, and a Signal Output Circuit According to the Present Disclosure

2. First Embodiment

3. Second Embodiment

4. Third embodiment, and Others

[General Description of a Display Device, a Method of Driving the Display Device, and a Signal Output Circuit According to the Present Disclosure]

A signal output circuit of the present disclosure, a signal output circuit in a display device of the present disclosure, or a signal output circuit that is used by a method of driving the display device of the present disclosure (these signal output circuits will also be hereinafter referred to simply as the signal output circuit of the present disclosure) may further include:

a power supply voltage node to which a predetermined power supply voltage is applied; and

a fourth switch provided between the power supply voltage node and an output node,

wherein, during the scanning period for scanning the display elements row by row, the fourth switch may be put into in a conductive state while a first switch and a second switch are in a non-conductive state, between a state where the first switch is non-conductive while the second switch is conductive and a state where the first switch is conductive while the second switch is non-conductive.

In this case, the signal output circuit may further include a precharge control circuit that controls the value of a precharge voltage to be applied to the data line connected to the output node, by controlling the duration of time during which the fourth switch is in a conductive state.

In this case, based on the value of a gradation signal, the precharge control circuit may control the duration of time during which the fourth switch is in a conductive state.

The signal output circuit of the present disclosure including the above described various preferred structures may further include a bias control circuit that controls the value of the bias current of the source amplifier based on the value of the gradation signal.

In this case, the bias control circuit may control the value of the bias current of the source amplifier based on the value of the gradation signal.

The signal output circuit of the present disclosure including the above described various preferred structures may further include a differential reception unit that receives data transmitted from an external timing controller, and be designed to generate the gradation signal based on the received data, and

the conductive/non-conductive state of the power supply path of the differential amplifier in the differential reception unit is controlled based on a signal indicating whether the external timing controller is transmitting data that contributes to image display.

The signal output circuit of the present disclosure including the above described various preferred structures can be formed with known circuit elements and the like. The same applies to the power supply unit and the scanning circuit, which will be described later.

The display device may be a so-called monochrome display structure, or may be a color display structure. In the case of a color display structure, each one pixel may be formed with sub-pixels. Specifically, each one pixel may be formed with the three sub-pixels of a red light emitting sub-pixel, a green light emitting sub-pixel, and a blue light emitting sub-pixel. Each one pixel may be formed with a set of sub-pixels further including one or more sub-pixels in addition to those three sub-pixels (such as a set of sub-pixels further including a white light emitting sub-pixel for increasing luminance, a set of sub-pixels further including a complementary-color light emitting sub-pixel for expanding the color reproduction range, a set of sub-pixels further including a yellow light emitting sub-pixel for expanding the color reproduction range, or a set of sub-pixels further including yellow and cyan light emitting sub-pixels for expanding the color reproduction range).

Examples of values of pixels of the display device include some resolutions for image display, such as (1920, 1035), (720, 480), and (1280, 960), as well as VGA (640, 480), S-VGA (800, 600), XGA (1024, 768), APRC (1152, 900), S-XGA (1280, 1024), U-XGA (1600, 1200), HD-TV (1920, 1080), and Q-XGA (2048, 1536). However, the values of pixels are not limited to the above.

The light emitting unit of a current drive type in a display element may be an organic electroluminescence light emitting unit, an LED light emitting unit, or a semiconductor laser light emitting unit, for example. These light emitting units can be formed with known materials and techniques. So as to form a flat-type display device, it is particularly preferable to form light emitting units with organic electroluminescence light emitting units.

The display elements forming a display unit are formed in a plane (or are formed on a support, for example), and each light emitting unit is formed above the drive circuit for driving the light emitting unit, with an interlayer insulating film being provided in between, for example.

The drive circuit for driving a light emitting unit may be a circuit that includes transistors and a capacitance unit, for example. The transistors forming the drive circuit may be n-channel thin-film transistors (TFT), for example. The transistors may be of an enhancement type or a depression type. In an n-channel transistor, an LDD structure (Lightly Doped Drain structure) maybe formed. In some cases, an LDD structure may be asymmetrically formed. For example, a large current is applied to the drive transistor when the display element emits light. Therefore, an LDD structure maybe formed only in the source/drain region that serves as the drain region at a time of light emission. Alternatively, p-channel thin-film transistors may be used, for example. The structure of the drive circuit is not particularly limited, as long as the structure is compatible with the operation of the present disclosure in which a reference voltage and a video signal voltage are alternately applied to the data line.

As for the two source/drain regions in one transistor, the term “the one source/drain region”, which means the source/drain region connected to the power supply side, is used in some cases. A conductive state of a transistor means a state where a channel is formed between the source/drain regions. Current may or may not flow from the one source/drain region to the other source/drain region in such a transistor. Meanwhile, anon-conductive state of a transistor means a state where a channel is not formed between the source/drain regions. The source/drain regions may be formed from a conductive material such as impurity-containing polysilicon or amorphous silicon. Other than that, the source/drain regions may be formed from a metal, an alloy, conductive particles, a stack structure of such materials, or a layer made of an organic material (a conductive polymer).

The capacitance unit forming the drive circuit may include one electrode, the other electrode, and a dielectric layer interposed between these electrodes. The above described transistors and the capacitance unit, which constitute the drive circuit, are formed in a plane (or are formed on a support, for example), and the light emitting unit is formed above the transistors and the capacitance unit of the drive circuit, with an interlayer insulating film being provided in between, for example. The other source/drain region of the drive transistor is connected to one end of the light emitting unit (the anode electrode of the light emitting unit) via a contact hole, for example. Alternatively, the transistors maybe formed on a semiconductor substrate or the like.

Various kinds of interconnects, such as the scanning lines, the data lines, and power supply lines that will be described later, are formed on a plane (or on a support). These interconnects may have conventional configurations or structures.

Examples of materials that can form the support and the substrate described later include not only glass materials such as high strain point glass, soda glass (Na₂O.CaO.SiO₂) borosilicate glass (Na₂O.B₂O₃.SiO₂), forsterite (2MgO.SiO₂), and lead glass (Na₂O.PbO.SiO₂), but also flexible polymeric materials such as polyethersulfone (PES), polyimide, polycarbonate (PC), and polyethylene terephthalate (PET). The surfaces of the support and the substrate may be provided with various kinds of coatings. The materials forming the support and the substrate may be the same or may be different from each other. With a support and a substrate made of a flexible polymeric material, a display device with flexibility can be formed.

The conditions shown in each expression in this specification are satisfied not only when the expression is true in strict mathematical terms, but also when the expression is substantially true. For an expression to be true, variations are allowed to exist in designing or manufacturing display elements and display devices.

In the timing charts to be used in the description below, the lengths (time lengths) of the abscissa axes indicating respective periods are schematically shown, and do not indicate the proportions of the time lengths of the respective periods. The same applies to the ordinate axes. The waveforms in the timing charts are also schematically shown.

### First Embodiment

A first embodiment relates to a display device, a method of driving the display device, and a signal output circuit according to the present disclosure.

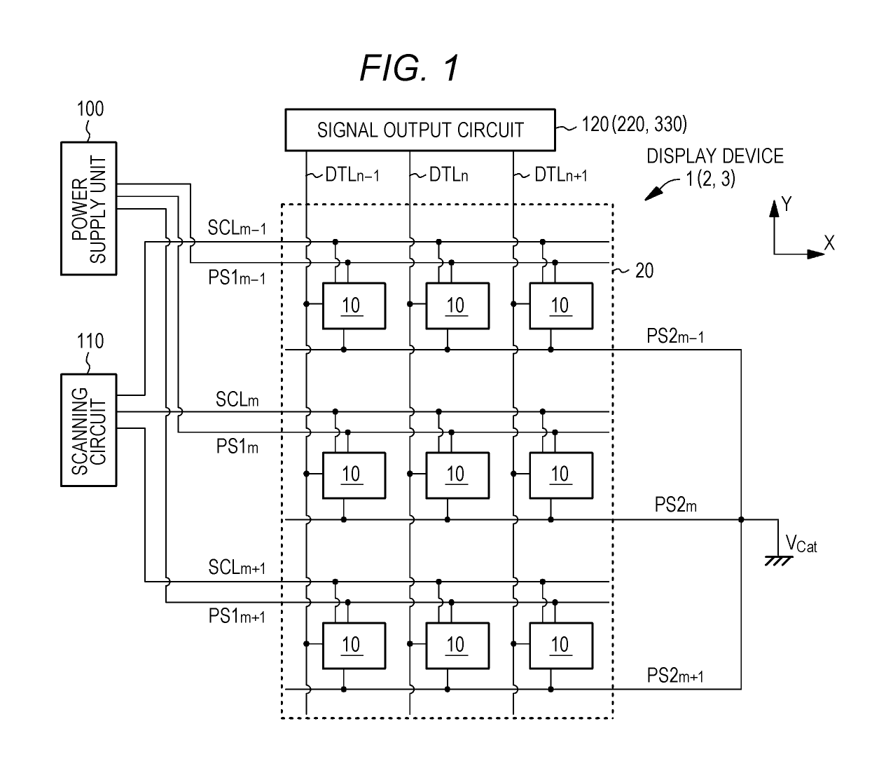

FIG. 1 is a conceptual diagram of the display device according to the first embodiment. The display device 1 includes: a display unit 20 in which display elements 10 each including a light emitting unit of a current drive type and a drive circuit that drives the light emitting unit are connected to scanning lines SCL extending in the row direction and data lines DTL extending in the column direction, and are arranged in a two-dimensional matrix fashion; and a signal output circuit 120 that alternately supplies a reference voltage and a video signal voltage to the data lines DTL. A scanning signal is supplied from a scanning circuit 110 to the scanning lines SCL. The light emitting unit forming a display element 10 is formed with an organic electroluminescence light emitting unit, for example.

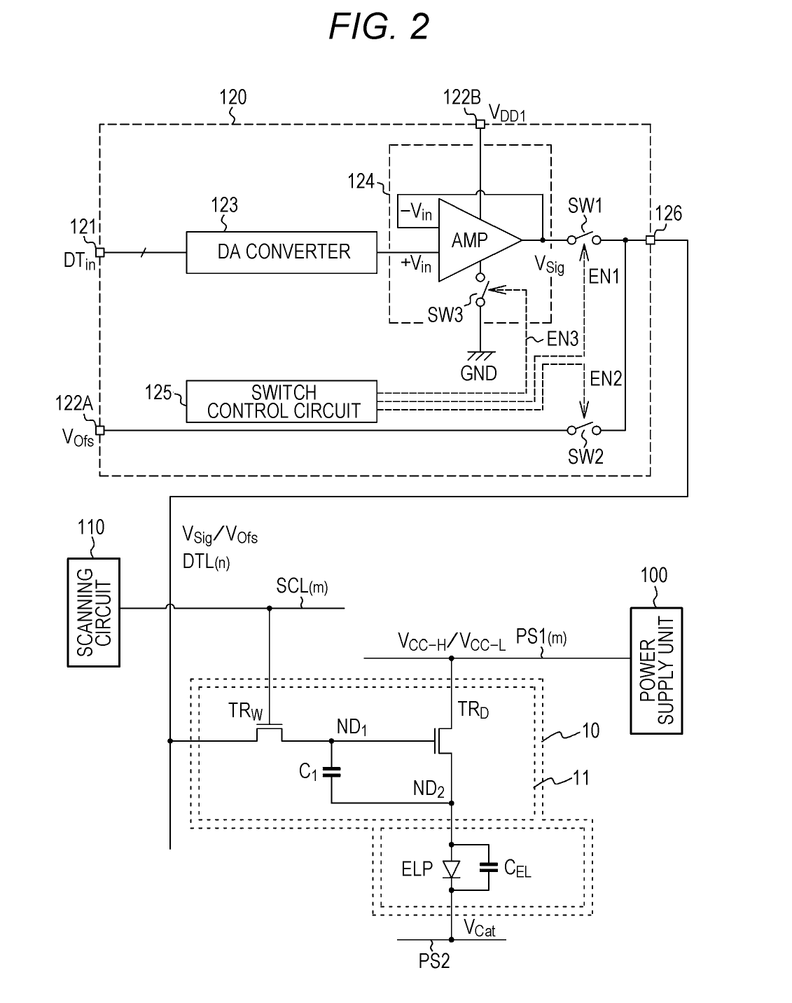

The display unit 20 further includes power supply lines PS1 connected to the display elements 10 arranged in the row direction, and second power supply lines PS2 connected to all the display elements 10. Predetermined voltages (V_{CC-H} and V_{CC-L}, which will be described later) are supplied to the power supply lines PS1 from a power supply unit 100. A common voltage (V_{Cat}, which will be described later) is supplied to the second power supply lines PS2. The relations of connection of the display elements 10 with the power supply lines PS1, the power supply line PS2, the scanning lines SCL, and the data lines DTL will be described later in detail, with reference to FIG. 2.

The region (display region) in which the display unit 20 displays an image is formed with N display elements 10 arranged in the row direction (the X-direction in FIG. 1) and M display elements 10 arranged in the column direction (the Y-direction in FIG. 1), which are a total of (N×M) display elements 10 arranged in a two-dimensional matrix fashion. The number of rows of the display elements 10 in the display region is M, and the number of display elements 10 forming each one row is N. Although (3×3) display elements 10 are shown in FIG. 1, this is merely an example.

The number of the scanning lines SCL and the number of the power supply lines PS1 are both M. The display elements 10 of the mth row (m=1, 2, . . . , M) are connected to the mth scanning line SCLₘ and the mth power supply line PS1ₘ, and constitute one display element row.

The number of the data lines DTL is N. The display elements 10 of the nth column (n=1, 2, . . . , N) are connected to the nth data line DTLₙ.

The display device 1 is a monochrome display device, and one display element 10 forms one pixel. With a scanning signal from the scanning circuit 110, the display device 1 is line-sequentially scanned row by row. The display element 10 located in the mth row and the nth column will be hereinafter referred to as the (n, m)th display element 10 or the (n, m) the pixel.

In the display device 1, the respective display elements 10 forming the N pixels arranged in the mth row are simultaneously driven. In other words, the emission/non-emission timing in N display elements 10 arranged in the row direction is controlled collectively in the row to which the N display elements 10 belong. Where the display frame rate of the display device 1 is represented by FR (times/sec.), the scanning period per row (a so-called horizontal scanning period) is shorter than [(1/FR)×(1/M)] seconds when the display device 1 is line-sequentially scanned row by row.

Gradation signals DTᵢₙ corresponding to the image to be displayed are input to the signal output circuit 120 of the display device 1 from a device (not shown), for example. Of the gradation signals DTᵢₙ to be input, the gradation signal corresponding to the (n, m)th display element 10 will be represented by DT_{in(n, m)} in some cases. The video signal voltage to be applied to the data line DTLₙ by the signal output circuit 120 based on the value of the gradation signal DT_{in(n, m)} will be represented by V_{Sig(n, m)} or V_{Sig}_{_{—}}ₘ in some cases.

For ease of explanation, the number of gradation bits in the gradation signal DT_{in(n, m)} is four. The gradation value of the input signal DT_{in(n, m)} is 0 to 15 in accordance with the luminance of the image to be displayed. In this case, the greater the gradation value, the higher the luminance of the image to be displayed.

FIG. 2 shows a schematic block diagram for explaining the structure of the part of the signal output circuit that contributes to driving of the nth data line, and a schematic circuit diagram for explaining the relations of connection of the (m, n)th display element with the signal output circuit, the scanning circuit, and the power supply unit.

The structure of the signal output circuit 120 is now described in detail. The signal output circuit 120 includes:

an output node 126 to which the data line DTLₙ is connected;

a reference voltage node 122A to which a reference voltage V_{Ofs} is applied;

a source amplifier 124 that outputs a video signal voltage V_{Sig} in accordance with an input gradation signal DTᵢₙ;

a first switch SW1 provided between the output side of the source amplifier 124 and the output node 126;

a second switch SW2 provided between the reference voltage node 122A and the output node 126; and

a third switch SW3 provided in the power supply path of the source amplifier 124.

The conductive/non-conductive states of the first switch SW1, the second switch SW2, and the third switch SW3 are controlled based on signals EN1, EN2, and EN3 from a switch control circuit 125.

Reference numeral 121 indicates a node to which gradation signals DT_{in(n, 1)} through DT_{in(n, M)} are sequentially input while the display device 1 is scanned. Reference numeral 122B indicates a node to which a predetermined voltage V_{DD1} for activating the source amplifier 124 is supplied.

The value of the voltage V_{DD1} is set to such a value that the source amplifier 124 can output the maximum design value of the video signal voltage V_{Sig} without difficulty.

The gradation signal DTᵢₙ that is input through the node 121 is converted into an analog signal by a DA converter 123, and is then input to the input side of the source amplifier 124 that is formed with a non-inverting amplifier circuit, for example. The video signal voltage V_{Sig} is then output from the output side of the source amplifier 124.

As the voltage for activating the source amplifier 124, the voltage V_{DD1} is supplied from the node 122B. In the example shown in FIG. 2, the power supply path of the source amplifier 124 is the path extending from the node 122B to the ground (GND). The third switch SW3 is provided in this path. Although the switch is provided on the ground side in the example shown in the drawing, switches may be provided on both the ground side and the power supply side.

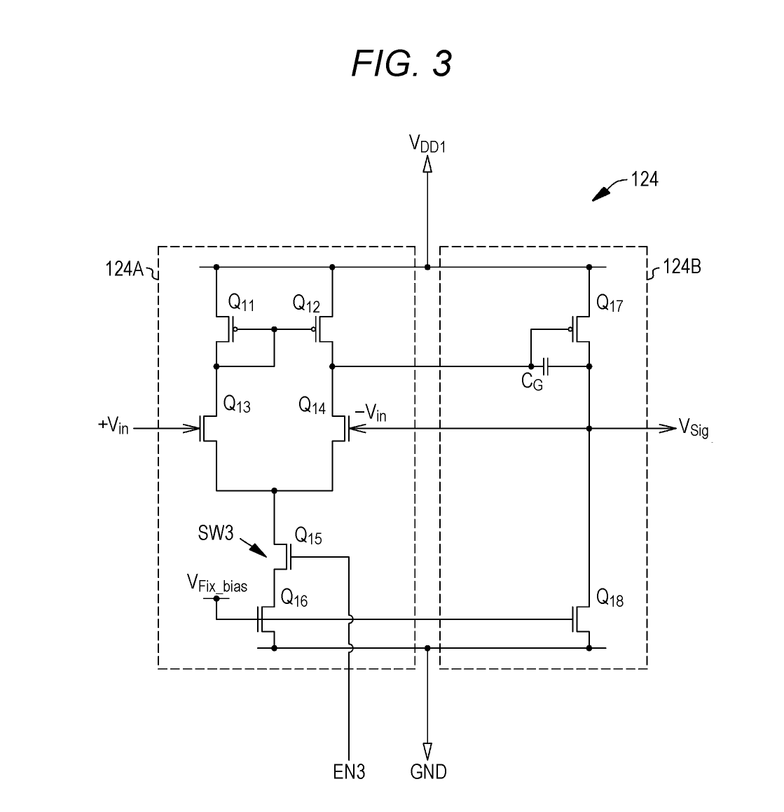

The structure of the source amplifier 124 is not particularly limited. Referring to FIGS. 3 through 5, three example structures of the source amplifier 124 are described below.

FIG. 3 is a schematic circuit diagram for explaining an example structure of a source amplifier.

The source amplifier 124 includes a transistor that is a field effect transistor (FET), for example. The source amplifier 124 is formed with a differential amplifier stage 124A and a gain stage 124B, for example. The differential amplifier stage 124A is formed with a current mirror circuit that includes p-channel transistors Q₁₁ and Q₁₂, and n-channel transistors Q₁₃ and Q₁₄, and an output of the DA converter 123 is applied to the gate of the transistor Q₁₃. The gain stage 124B is formed with a p-channel transistor Q₁₇, an n-channel transistor Q₁₈, and a capacitor C_{G}.

The differential amplifier stage 124A is grounded via n-channel transistors Q₁₅ and Q₁₆ that are connected in series.

The transistor Q₁₆ is used for setting the value of the bias current of the source amplifier 124, and a predetermined fixed voltage V_{Fix}_{_{—}}_{bias} is applied to the gate thereof. The value of V_{Fix}_{_{—}}_{bias} is appropriately set based on the specifications of the display device 1.

The signal EN3 from the switch control circuit 125 is applied to the gate of the above described transistor Q₁₅. The transistor Q₁₅ is connected in series to the power supply path of the source amplifier 124, and corresponds to the third switch SW3.

Although the signal receiving side of the source amplifier shown in FIG. 3 is formed with an n-channel transistor, it can be formed with a p-channel transistor. This is described below, with reference to a drawing.

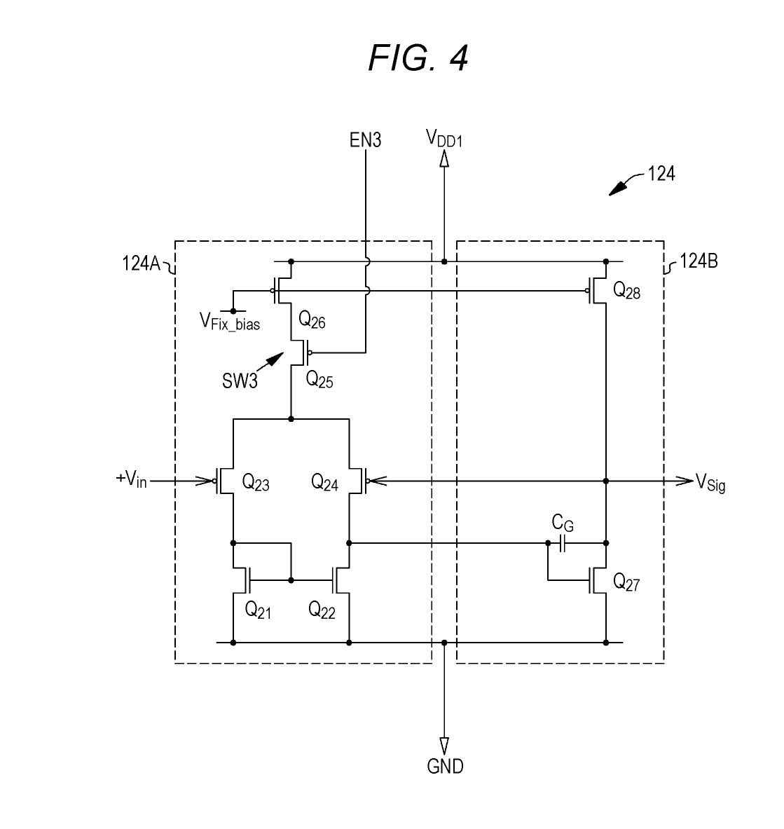

FIG. 4 is a schematic circuit diagram for explaining another example structure of a source amplifier.

In this structure, the differential amplifier stage 124A is formed with a current mirror circuit that includes n-channel transistors Q₂₁ and Q₂₂, and p-channel transistors Q₂₃ Q₂₄, and an output of the DA converter 123 is applied to the gate of the transistor Q₂₃. The gain stage 124B is formed with an n-channel transistor Q₂₇, a p-channel transistor Q₂₈, and a capacitor C_{G}.

The differential amplifier stage 124A is connected to the power supply side via p-channel transistors Q₂₅ and Q₂₆ that are connected in series.

The transistor Q₂₆ is used for setting the value of the bias current of the source amplifier 124, and a predetermined fixed voltage V_{Fix}_{_{—}}_{bias} is applied to the gate thereof. The value of V_{Fix}_{_{—}}_{bias} is appropriately set based on the specifications of the display device 1.

The signal EN3 from the switch control circuit 125 is applied to the gate of the above described transistor Q₂₅. The transistor Q₂₅ is connected in series to the power supply path of the source amplifier 124, and corresponds to the third switch SW3.

The examples shown in FIGS. 3 and 4 are structures in which the current path in the differential amplifier stage 124A is opened and closed by the third switch SW3. However, the current path in both the differential amplifier stage 124A and the gain stage 124B can be opened and closed by the third switch SW3. This is described below, with reference to a drawing.

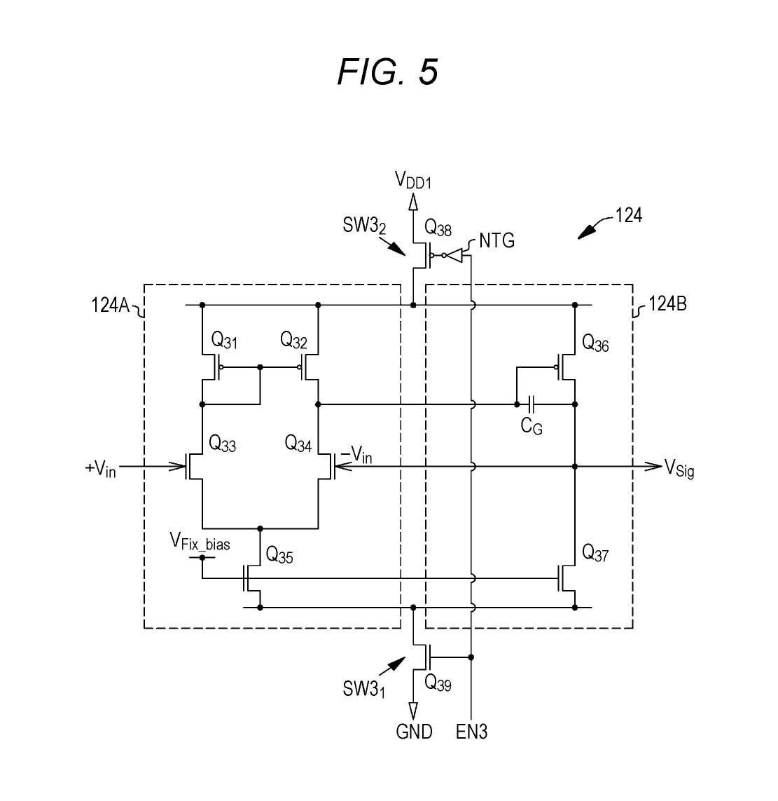

FIG. 5 is a schematic circuit diagram for explaining yet another example structure of a source amplifier.

The differential amplifier stage 124A is formed with a current mirror circuit that includes p-channel transistors Q₃₁ and Q₃₂, and n-channel transistors Q₃₃ and Q₃₄, and an output of the DA converter 123 is applied to the gate of the transistor Q₃₃. The gain stage 124B is formed with a p-channel transistor Q₃₆, an n-channel transistor Q₃₇, and a capacitor C_{G}. The differential amplifier stage 124A is grounded via an n-channel transistor Q₃₅. The n-channel transistors Q₃₅ and Q₃₇ are used for setting the value of the bias current of the source amplifier 124, and a predetermined fixed voltage V_{Fix}_{_{—}}_{bias} is applied to the gates of those transistors. A p-channel transistors Q₃₈ and an n-channel transistor Q₃₉ are connected in series to the power supply path of the source amplifier 124, and corresponds to the third switch SW3. In FIG. 5, the third switch on the ground side is denoted by reference numeral SW3₁, and the third switch on the power supply side is denoted by reference numeral SW3₂. The signal EN3 from the switch control circuit 125 is applied to the gates of the transistors Q₃₈ and Q₃₉. More specifically, the signal EN3 is applied directly to the transistor Q₃₈, and the signal EN3 is applied to the transistor Q₃₉ via an inverting circuit NTG. Alternatively, only one of the transistors Q₃₈ and Q₃₉ may be provided.

The structure of the signal output circuit 120 has been described so far. Next, the operation of the signal output circuit 120, which is the features of the present disclosure, is described.

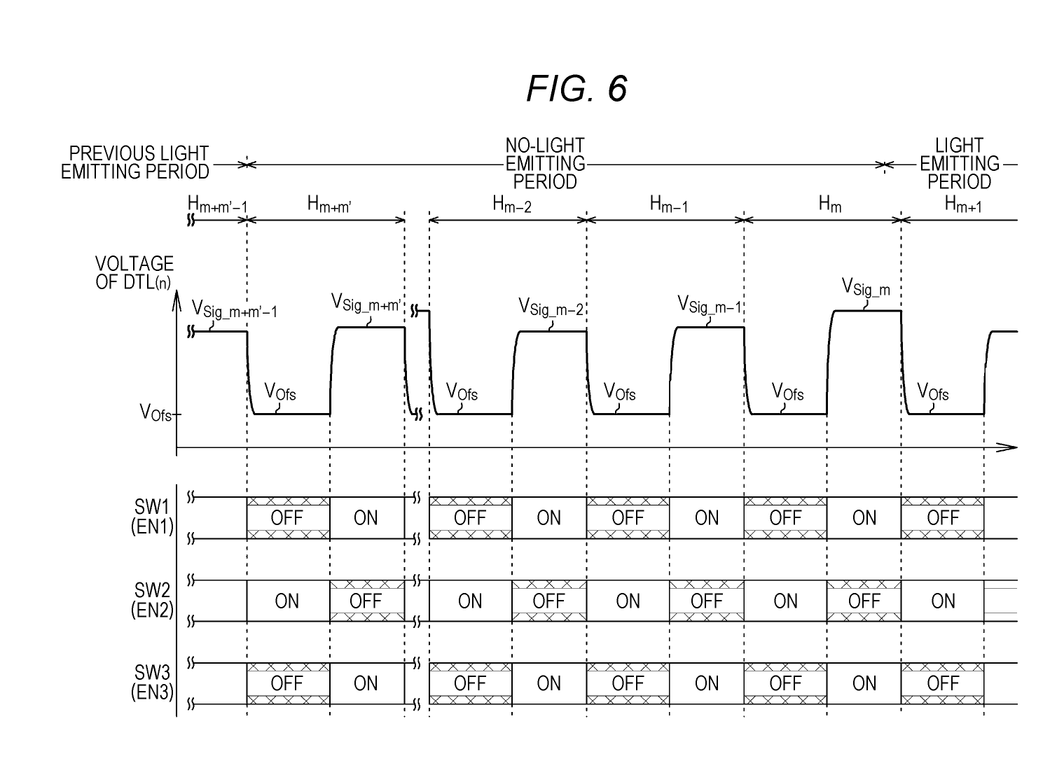

FIG. 6 is a schematic timing chart for explaining the operation of the signal output circuit.

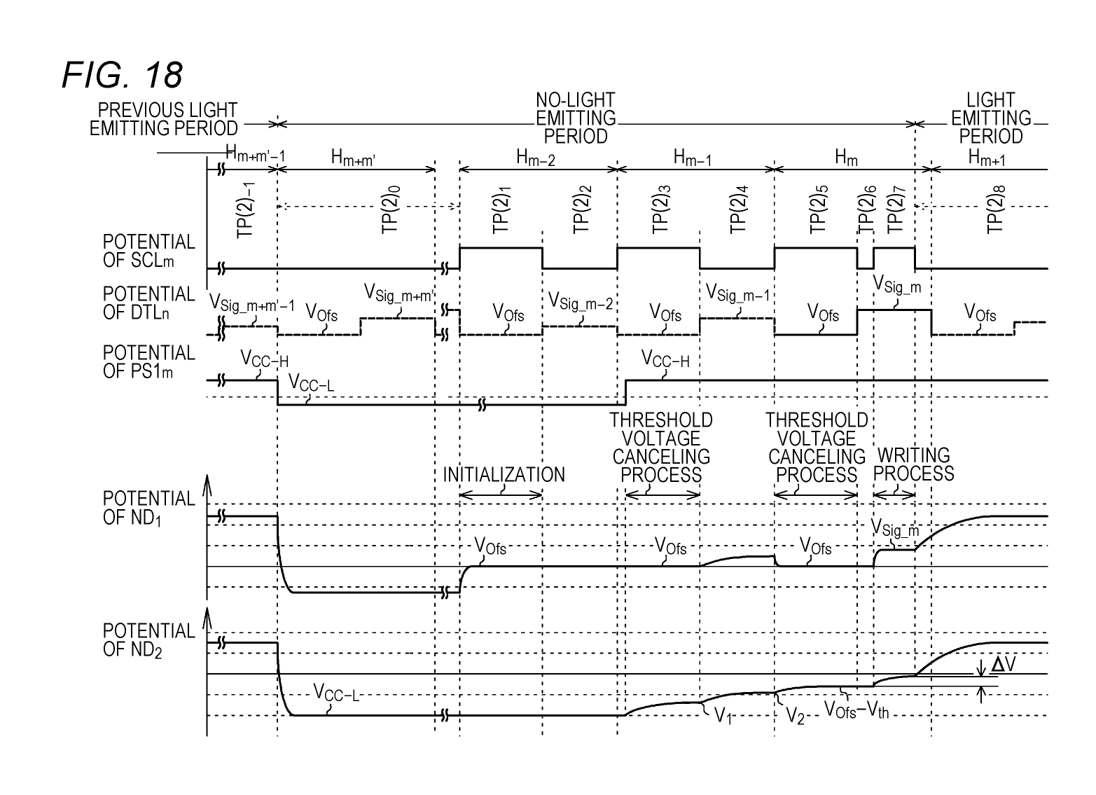

The waveform of the data line DTLₙ shown in FIG. 6 corresponds to the waveform of the data line DTLₙ shown in FIG. 18, which will be described later. The waveforms in FIG. 18 are schematically drawn, and blunt portions and the like of the waveforms are not shown. Hₘ₋₂, Hₘ₋₁, Hₘ, and Hₘ₊₁ shown in FIG. 6 represent the horizontal scanning periods corresponding to the (m−2)th, (m−1)th, mth, and (m+1)th display elements 10. The same applies to the other horizontal scanning periods. It should be noted that “previous light emitting period”, “no-light emitting period”, and “light emitting period” shown in FIG. 6 will be explained later in the last half of the description of the third embodiment with reference to FIG. 18 and others.

As described above, in the signal output circuit 120 shown in FIG. 2, the conductive/non-conductive states of the first switch SW1, the second switch SW2, and the third switch SW3 are controlled based on signals EN1, EN2, and EN3 from the switch control circuit 125. The switch control circuit 125 operates based on a clock signal supplied from outside, for example.

During a scanning period for scanning the display elements 10 row by row (or in a horizontal scanning period), switching is performed between a state where the first switch SW1 is non-conductive while the second switch SW2 is conductive and a state where the first switch SW1 is conductive while the second switch SW2 is non-conductive. Therefore, the reference voltage V_{Ofs} (0 volts, for example) and the video signal voltage V_{Sig} (0 to 15 volts, for example) are alternately supplied to the data line DTLₙ connected to the output node 126, as shown in FIG. 6.

In this case, the third switch SW3 is put into a conductive state when the first switch SW1 is put into a conductive state, and the third switch SW3 is put into a non-conductive state when the first switch SW1 is put into a non-conductive state.

Accordingly, when the output side of the source amplifier 124 is connected to the output node 126, the power supply path of the source amplifier 124 is not blocked, and the source amplifier 124 is in an operating state. When the output side of the source amplifier 124 is not connected to the output node 126 (or where there is no need to activate the source amplifier 124), the power supply path of the source amplifier 124 is blocked. With this, the power consumption by the source amplifier 124 can be made smaller than in a structure in which the source amplifier 124 is constantly operated.

Basically, the signal output circuit 120 needs to have the same number of source amplifiers 124 as the number of data lines DTL. As the power consumption by the source amplifier 124 is reduced, the allowance in terms of thermal design increases in the entire signal output circuit. Accordingly, higher integration of the semiconductor devices constituting the signal output circuit can also be achieved, and costs can be lowered.

Next, the structure of a display element 10 is described. As the operation of the entire display device is basically the same between the first embodiment and the second and third embodiments described later, it will be explained in detail in the last half of the description of the third embodiment.

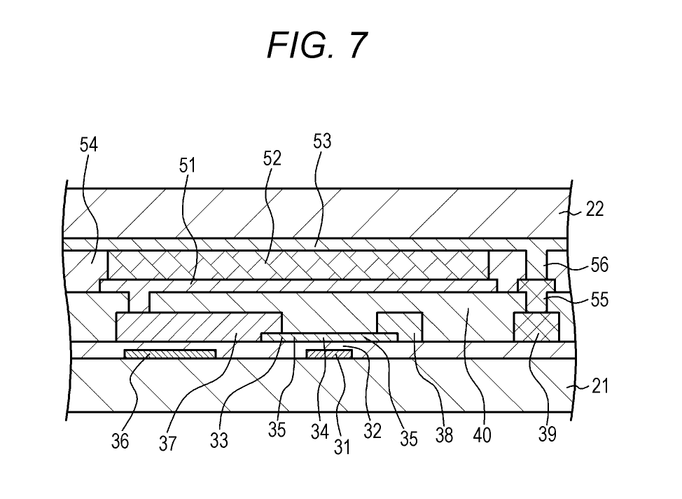

As shown in FIG. 2, the display element 10 includes a light emitting unit ELP of a current drive type and a drive circuit 11. The drive circuit 11 includes at least a drive transistor TR_{D} that has a gate electrode and source/drain regions, and a capacitance unit C₁, and current flows into the light emitting unit ELP via the source/drain regions of the drive transistor TR_{D}. As will be described later in detail with reference to FIG. 7, the display element 10 has a structure in which the drive circuit 11 and the light emitting unit ELP connected to this drive circuit 11 are stacked.

In addition to the drive transistor TR_{D}, the drive circuit 11 further includes a write transistor TR_{W}. The drive transistor TR_{D} and the write transistor TR_{W} are formed with n-channel TFTs. Alternatively, the write transistor TR_{W} may be formed with a p-channel TFT. The drive circuit 11 may further include another transistor.

The capacitance unit C₁ is used to hold the voltage of the gate electrode for the source region of the drive transistor TR_{D} (a so-called gate-source voltage). The “source region” in this case means the source/drain region that serves as the “source region” when the light emitting unit ELP emits light. In a state where the display element 10 emits light, one source/drain region (the one connected to the power supply line PS1 in FIG. 2) of the drive transistor TR_{D} serves as the drain region, and the other source/drain region (one end of the light emitting unit ELP, or specifically, the one connected to the anode electrode) serves as the source region. One electrode and the other electrode that constitute the capacitance unit C₁ are connected to the other source/drain region and the gate electrode of the drive transistor TR_{D}, respectively.

The write transistor TR_{W} includes a gate electrode connected to the scanning line SCL, one source/drain region connected to the data line DTL, and the other source/drain region connected to the gate electrode of the drive transistor TR_{D}.

The gate electrode of the drive transistor TR_{D} forms a first node ND₁ to which the other source/drain region of the write transistor TR_{W} and the other electrode of the capacitance unit C₁ are connected. The other source/drain region of the drive transistor TR_{D} forms a second node ND₂ to which the one electrode of the capacitance unit C₁ and the anode electrode of the light emitting unit ELP are connected.

The other end (specifically, the cathode electrode) of the light emitting unit ELP is connected to the second power supply line PS2. As shown in FIG. 1, the second power supply line PS2 is the same among all the display elements 10.

A predetermined voltage V_{Cat}, which will be described later, is applied to the cathode electrode of the light emitting unit ELP through the second power supply line PS2. The capacitance of the light emitting unit ELP is denoted by C_{EL}. The threshold voltage required by the light emitting unit ELP to emit light is represented by V_{th-EL}. That is, when a voltage of V_{th-EL} or higher is applied between the anode electrode and the cathode electrode of the light emitting unit ELP, the light emitting unit ELP emits light.

The light emitting unit ELP has a known configuration or structure that is formed with an anode electrode, a hole transport layer, a light emitting layer, an electron transport layer, a cathode electrode, and the like.

The drive transistor TR_{D} shown in FIG. 2 is set to such a voltage as to operate in a saturation region in a state where the display element 10 emits light, and is driven so as to apply a drain current I_{ds} according to the equation (1) shown below. As described above, in a state where the display element 10 emits light, the one source/drain region of the drive transistor TR_{D} serves as the drain region, and the other source/drain region serves as the source region. For ease of explanation, the one source/drain region of the drive transistor TR_{D} will be hereinafter also referred to simply as the drain region, and the other source/drain region will be hereinafter also referred to simply as the source region. In the description below,
μ: effective mobility,
L: channel length,
W: channel width,
V_{gs}: voltage of the gate electrode for the source region,
Vₜₕ: threshold voltage, and
Cₒₓ: (relative permittivity of gate insulating layer)×(permittivity of vacuum)/(thickness of gate insulating layer) k≡(1/2)·(W/L)·Cₒₓ.

I_{ds}=k·μ·(V_{gs}−Vₜₕ)² (1)

As this drain current I_{ds} flows in the light emitting unit ELP, the light emitting unit ELP of the display element 10 emits light. Furthermore, light intensity at the light emitting unit ELP of the display element 10 is controlled in accordance with the magnitude of the value of this drain current I_{ds}.

In the description below, the values of voltages or potentials are set as below. However, these values are set for ease of explanation, and the values of voltages or potentials are not limited to these values.

V_{Sig}: the video signal voltage

. . . 0 to 15 volts

V_{Ofs}: the reference voltage to be applied to the gate electrode (the first node ND₁) of the drive transistor TR_{D}

. . . 0 volts

V_{CC-H}: the drive voltage for applying current to the light emitting unit ELP

. . . 20 volts

V_{CC-L}: the initializing voltage for initializing the potential of the other source/drain region (the second node ND₂) of the drive transistor TR_{D}

. . . 10 volts

Vₜₕ: the threshold voltage of the drive transistor TR_{D}

. . . 3 volts

V_{Cat}: the voltage to be applied to the cathode electrode of the light emitting unit ELP

. . . 0 volts

V_{th-EL}: the threshold voltage of the light emitting unit ELP

. . . 4 volts

FIG. 7 is a schematic cross-sectional view of a part of the display unit including a display element. The transistors TR_{D} and TR_{W} and the capacitance unit C₁, which constitute the drive circuit 11, are formed on a support 21, and the light emitting unit ELP is formed above the transistors TR_{D} and TR_{W} and the capacitance unit C₁ of the drive circuit 11, with an interlayer insulating film 40 being provided in between, for example. The other source/drain region of the drive transistor TR_{D} is connected to the anode electrode of the light emitting unit ELP via a contact hole. In FIG. 7, only the drive transistor TR_{D} is shown. The other transistors are hidden and are not shown.

Referring now to FIG. 7, the structure of the display element 10 is specifically described. The drive transistor TR_{D} includes a gate electrode 31, a gate insulating layer 32, source/drain regions 35, 35 formed in a semiconductor layer 33, and a channel forming region 34 that is the portion of the semiconductor layer 33 located between the source/drain regions 35, 35. Meanwhile, the capacitance unit C₁ includes the other electrode 36, a dielectric layer formed with an extending portion of the gate insulating layer 32, and the one electrode 37. The gate electrode 31, part of the gate insulating layer 32, and the other electrode 36 of the capacitance unit C₁ are formed on the support 21. One source/drain region 35 of the drive transistor TR_{D} is connected to an interconnect 38 (corresponding to the power supply line PS1), and the other source/drain region 35 is connected to the one electrode 37. The drive transistor TR_{D}, the capacitance unit C₁, and others are covered with the interlayer insulating film 40, and the light emitting unit ELP formed with an anode electrode 51, a hole transport layer, a light emitting layer, an electron transport layer, and a cathode electrode 53 is formed on the interlayer insulating film 40. In the drawing, the hole transport layer, the light emitting layer, and the electron transport layer are represented by a layer 52. A second interlayer insulating film 54 is provided on the portion of the interlayer insulating film 40 on which the light emitting unit ELP is not formed, and a transparent substrate 22 is placed over the second interlayer insulating film 54 and the cathode electrode 53. Light emitted from the light emitting layer passes through the substrate 22, and is released to the outside. The one electrode 37 and the anode electrode 51 are connected by a contact hole formed in the interlayer insulating film 40. The cathode electrode 53 is connected to an interconnect 39 (corresponding to the second power supply line PS2) provided on an extending portion of the gate insulating layer 32, via contact holes 56 and 55 formed in the second interlayer insulating film 54 and the interlayer insulating film 40.

### Second Embodiment

The second embodiment also relates to a display device, a method of driving the display device, and a signal output circuit according to the present disclosure.

The second embodiment differs from the first embodiment primarily in that the signal output circuit further includes: a fourth switch provided between the power supply voltage node and the output node; a precharge control circuit that controls the value of the precharge voltage to be applied to the data line connected to the output node by controlling the duration of time during which the fourth switch is in a conductive state; and a bias control circuit that controls the value of the bias current of the source amplifier based on the value of a gradation signal.

A schematic diagram of a display device 2 according to the second embodiment should be the same as that in FIG. 1, except that the image display unit 1 is replaced with an image display unit 2, and the signal output circuit 120 is replaced with a signal output circuit 220.

The components other than the signal output circuit 220 in the display device 2 are the same as the corresponding components in the display device 1 of the first embodiment. Explanation of them is not made herein.

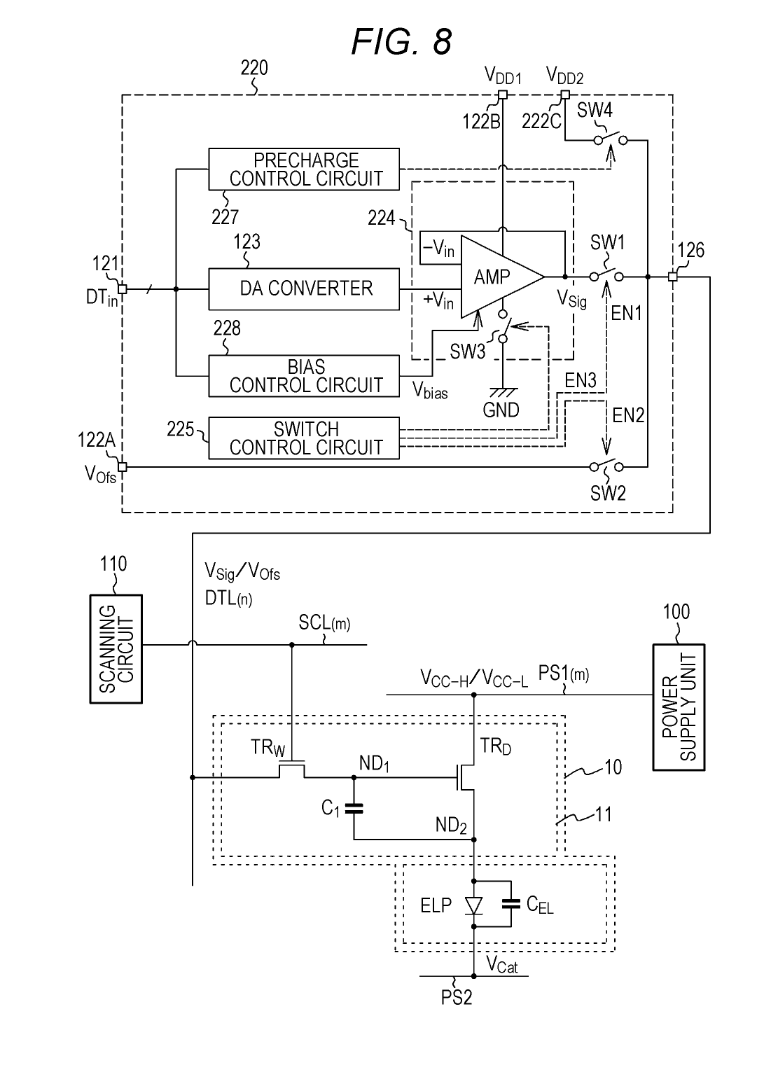

FIG. 8 shows a schematic block diagram for explaining the structure of the part of the signal output circuit that contributes to driving of the nth data line, and a schematic circuit diagram for explaining the relations of connection of the (m, n)th display element with the signal output circuit, the scanning circuit, and the power supply unit.

The structure of the signal output circuit 220 is now described in detail. The signal output circuit 220 includes:

an output node 126 to which the data line DTLₙ is connected;

a reference voltage node 122A to which a reference voltage V_{Ofs} is applied;

a source amplifier 224 that outputs a video signal voltage V_{Sig} in accordance with an input gradation signal DTᵢₙ;

a first switch SW1 provided between the output side of the source amplifier 224 and the output node 126;

a second switch SW2 provided between the reference voltage node 122A and the output node 126; and

a third switch SW3 provided in the power supply path of the source amplifier 224. The components other than the source amplifier 224 are the same as the corresponding components described in the first embodiment with reference to FIG. 2.

The conductive/non-conductive states of the first switch SW1, the second switch SW2, and the third switch SW3 are controlled based on signals EN1, EN2, and EN3 from a switch control circuit 225. These switches are controlled at different times from those of the first embodiment.

The signal output circuit 220 according to the second embodiment further includes:

a power supply voltage node 222C to which a predetermined power supply voltage V_{DD2} is applied; and

a fourth switch SW4 provided between the power supply voltage node 222C and the output node 126.

The signal output circuit 220 further includes a precharge control circuit 227 that controls the value of the precharge voltage to be applied to the data line DTL connected to the output node 126, by controlling the duration of time during which the fourth switch SW4 is in a conductive state. Based on the value of a gradation signal DTᵢₙ, the precharge control circuit 227 controls the duration of time during which the fourth switch SW4 is in a conductive state.

The signal output circuit 220 according to the second embodiment further includes a bias control circuit 228 that controls the value of the bias current of the source amplifier 224 based on the value of the gradation signal DTᵢₙ. The bias control circuit 228 controls the value of the bias current of the source amplifier 224 based on the value of the gradation signal DTᵢₙ.

The structure of the source amplifier 224 is basically the same as the structure of the source amplifier 124 described in the first embodiment. Reference numeral 224A indicates a differential amplifier stage, and reference numeral 224B indicates a gain stage. A signal V_{bias} from the bias control circuit 228 is input to the gate of the transistor for setting the value of the bias current to be applied to the source amplifier 224, which differs from the first embodiment.

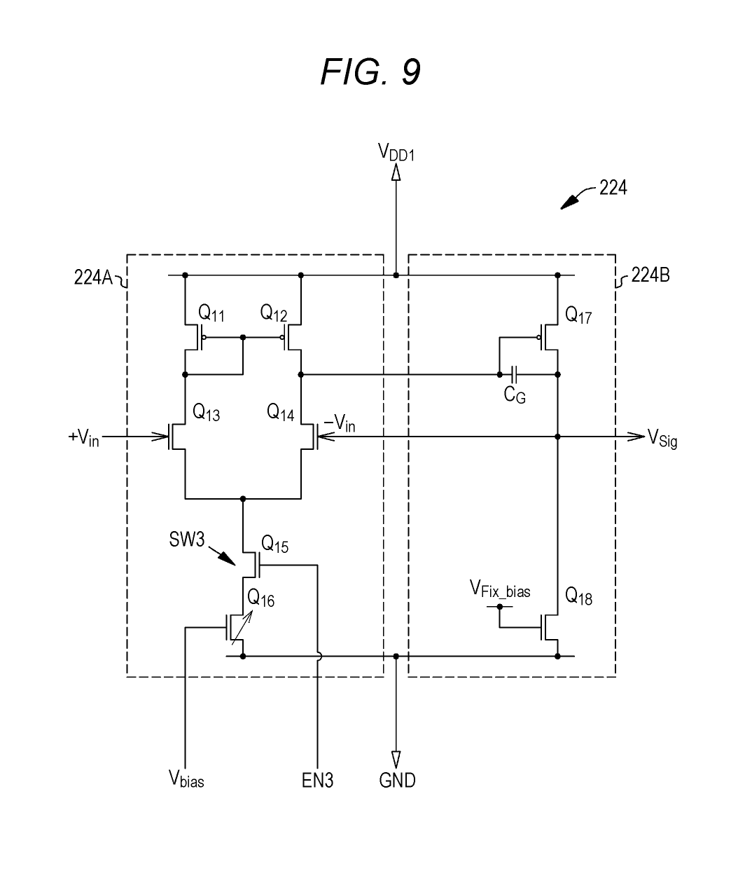

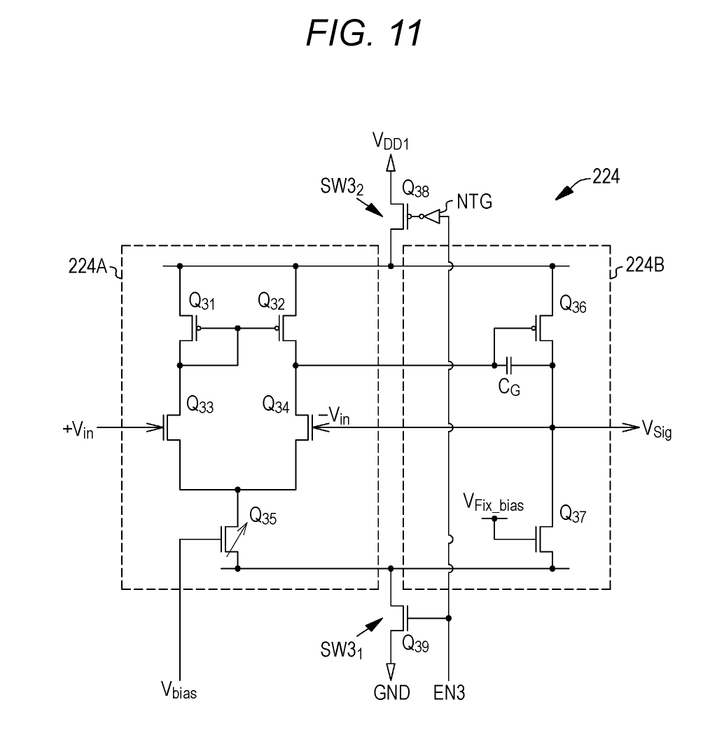

Referring now to FIGS. 9 through 11, example structures corresponding to the source amplifiers of the first embodiment described above with reference to FIGS. 3 through 5 are described.

FIG. 9 is a schematic circuit diagram for explaining an example structure of a source amplifier.

This structure is the same as the structure described above with reference to FIG. 3, except that the signal V_{bias} from the bias control circuit 228 is input to the gate of a transistor Q₁₆ in the differential amplifier stage 224A.

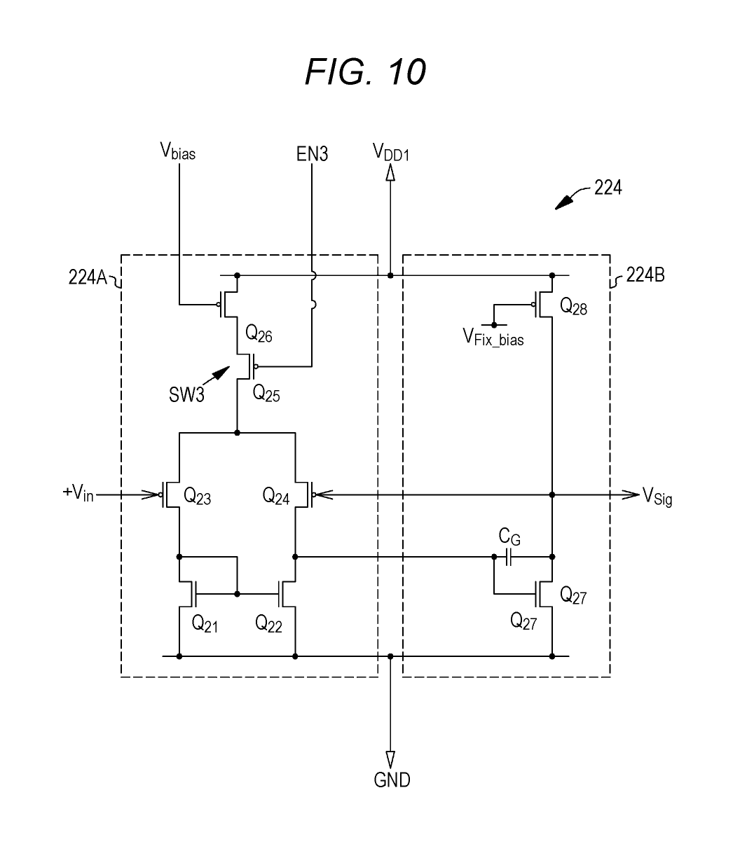

FIG. 10 is a schematic circuit diagram for explaining another example structure of a source amplifier.

This structure is the same as the structure described above with reference to FIG. 4, except that the signal V_{bias} from the bias control circuit 228 is input to the gate of a transistor Q₂₆ in the differential amplifier stage 224A.

FIG. 5 is a schematic circuit diagram for explaining yet another example structure of a source amplifier.

This structure is the same as the structure described above with reference to FIG. 5, except that the signal V_{bias} from the bias control circuit 228 is input to the gate of a transistor Q₃₅ in the differential amplifier stage 224A.

The structure of the signal output circuit 220 has been described so far. Next, the operation of the signal output circuit 220 is described in detail.

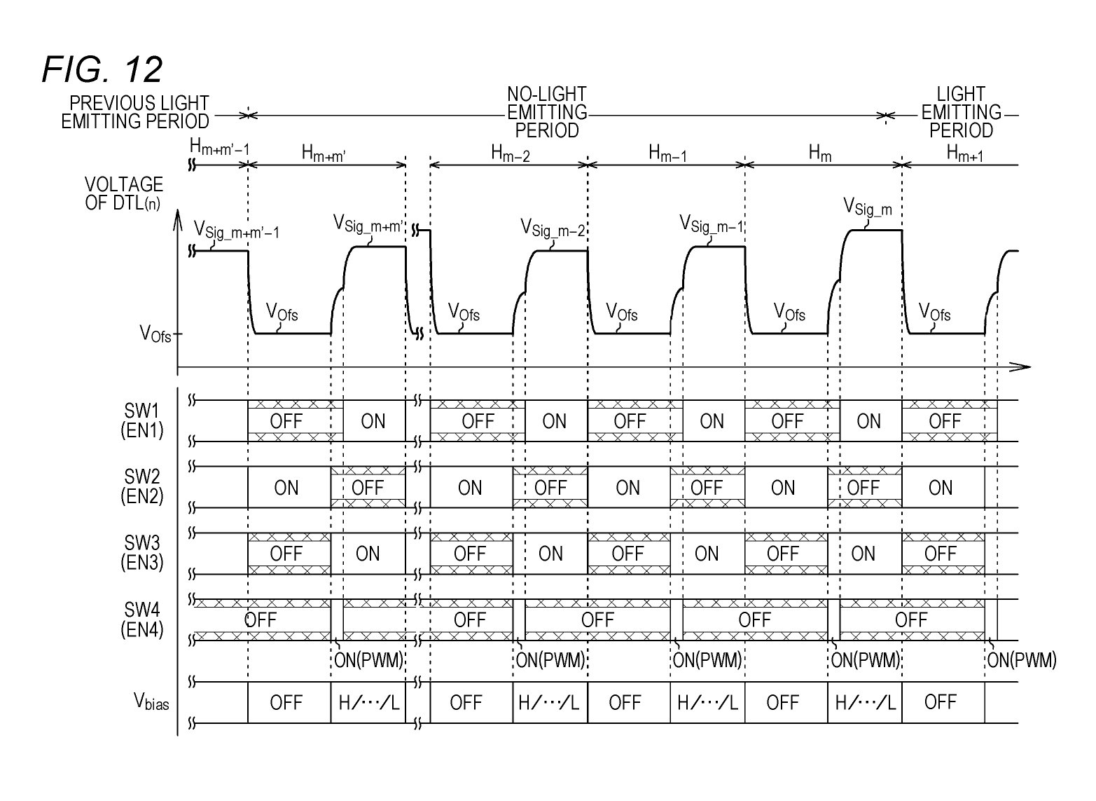

FIG. 12 is a schematic timing chart for explaining the operation of the signal output circuit.

FIG. 12 corresponds to FIG. 6, which has been referred to in the first embodiment. The waveform of the data line DTLₙ shown in FIG. 12 basically corresponds to the waveform of the data line DTLₙ shown in FIG. 18. For ease of explanation, the waveforms in FIG. 18 are schematically drawn, and blunt portions of the waveforms and changes in the waveforms caused by the supply of a precharge voltage are not shown.

In the signal output circuit 220, during a scanning period for scanning the display element 10 row by row (or in a horizontal scanning period), switching is performed between a state where the first switch SW1 is non-conductive while the second switch SW2 is conductive and a state where the first switch SW1 is conductive while the second switch SW2 is non-conductive, as in the signal output circuit 120 described in the first embodiment. Therefore, the reference voltage V_{Ofs} and the video signal voltage V_{Sig} are alternately supplied to the data line DTLₙ connected to the output node 126. The third switch SW3 is put into a conductive state when the first switch SW1 is put into a conductive state, and the third switch SW3 is put into a non-conductive state when the first switch SW1 is put into a non-conductive state.

Accordingly, the power supply path of the source amplifier 224 is blocked when there is no need to activate the source amplifier 224, and the power consumption by the source amplifier 224 can be reduced, as in the first embodiment.

In a case where the reference voltage V_{Ofs} and the video signal voltage V_{Sig} are alternately supplied to the data line DTL, however, current flows from the source amplifier 224 to the data line DTL in accordance with the load capacitance of the data line DTL and the like. At this point, heat is generated in the source amplifier 224 due to the current flowing through the data line DTL and the on-state resistance or the like of the transistor in the source amplifier 224.

It is possible to reduce the above heat generation by reducing a voltage variation in the output of the source amplifier 224.

Therefore, in the signal output circuit 220, during a scanning period for scanning the display element 10 row by row, the fourth switch SW4 is put into a conductive state while the first switch SW1 and the second switch SW2 are in a non-conductive state, between a state where the first switch SW1 is non-conductive while the second switch SW2 is conductive and a state where the first switch SW1 is conductive while the second switch SW2 is non-conductive. The precharge control circuit 227 controls the value of the precharge voltage to be applied to the data line DTL connected to the output node 126, by controlling the duration of time during which the fourth switch SW4 is in a conductive state.

Where the reference voltage V_{Ofs} is 0 volts, the precharge voltage level V_{pcg} is expressed by the equation (2) shown below. In the equation shown below,

t: the duration of time during which the fourth switch SW4 is in a conductive state, and

τ: the product of the load capacitance and the load resistance of the data line DTL.

V_{pcg}=V_{DD2}×{1−exp(−t/τ)} (2)

Based on the value of a gradation signal DTᵢₙ, the precharge control circuit 227 controls the duration of time during which the fourth switch SW4 is in a conductive state. The precharge control circuit 227 has a look-up table based on values of gradation signals DTᵢₙ.

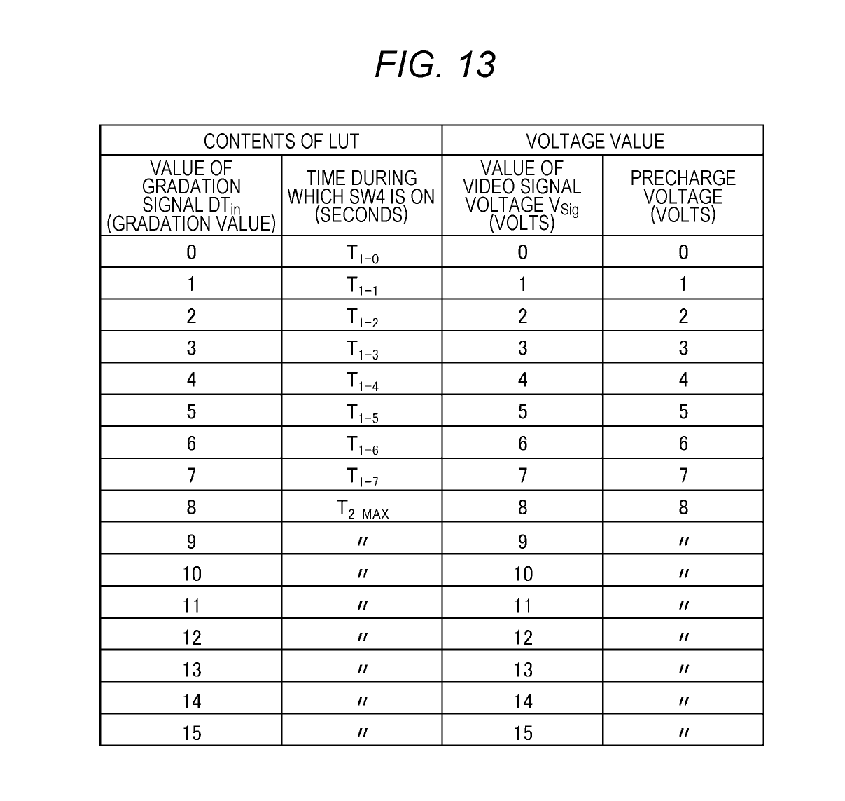

FIG. 13 is a table for explaining the structure of the look-up table for setting the precharge voltage.

In the example shown in FIG. 13, the maximum value of the precharge voltage is set to a value approximately half the maximum design value of the video signal voltage V_{Sig}. In a case where the video signal voltage V_{Sig} is lower than approximately half the maximum design value thereof, the precharge voltage is set to the same value as the video signal voltage V_{Sig}. In a case where the video signal voltage V_{Sig} is higher than approximately half the maximum design value thereof, the maximum value of the precharge voltage is set to a value approximately half the maximum design value of the video signal voltage V_{Sig}.

The value of the power supply voltage V_{DD2} shown in FIG. 8 and the values of T₁₋₀ through T_{2-MAx} in the look-up table should be appropriately set in accordance with the specifications of the display device and the like so that the above described precharging operation can be performed without any problem. For example, V_{DD2} may be equal to V_{DD1}, or V_{DD2} may be lower than V_{DD1}. Depending on the specifications of the display device, V_{DD2} may be almost equal to V_{DD1}/2.

It is possible to reduce a voltage variation in the output of the source amplifier 224 by supplying the above described precharge voltage. Accordingly, heat generation in the source amplifier 224 is reduced. In the portion including the fourth switch SW4, heat is generated due to the charge/discharge current accompanying the precharge. However, in the entire signal output circuit, the heat generating unit is divided into the V_{DD1} system and the V_{DD2} system, and accordingly, the allowance in thermal design becomes larger. Thus, higher integration of the semiconductor devices constituting the signal output circuits can also be achieved, and costs can be lowered. In a case where no charge/discharge current is generated and precharge is not required, such as when black is displayed (V_{Sig}=0 volts, for example), the time during which the switch SW4 is on may be set to 0 seconds, and precharge may not be performed.

In the signal output circuit 220, the value of the bias current of the source amplifier 224 is controlled based on the value of a gradation signal DTᵢₙ.

The bias control circuit 228 has values of gradation signals DTᵢₙ, and a look-up table based on values of gradation signals DTᵢₙ.

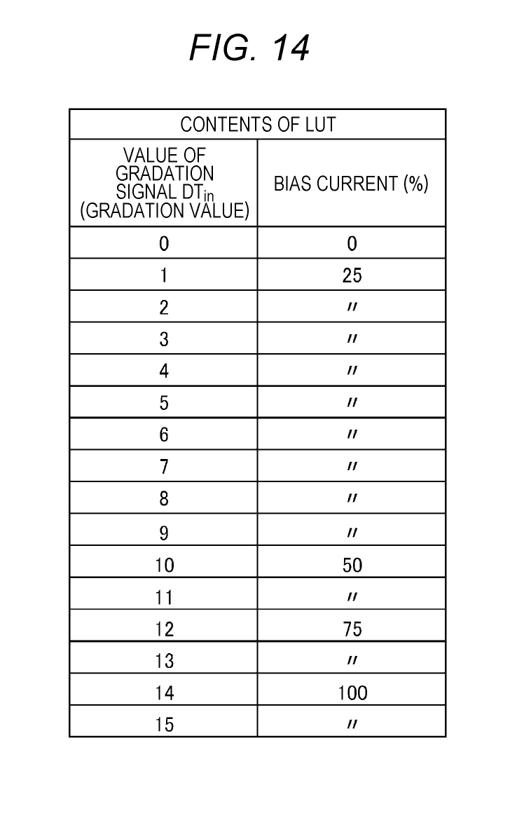

FIG. 14 is a table for explaining the structure of the look-up table for setting the bias current.

In the example shown in FIG. 14, the bias current is controlled at the five levels of 100 percent (H-level), 75 percent, 50 percent, 25 percent, and 0 percent (L-level), with 100 percent being the value to be set when the video signal voltage V_{Sig} has its maximum design value. In FIG. 12, these five levels are simplified and are shown as “H/ . . . /L”.

In qualitative terms, the amount of the current to be written into the data line increases as the value of the video signal voltage V_{Sig} becomes greater, and therefore, control is performed so that the bias current becomes higher.

With this, the bias level at the time when a video signal voltage V_{Sig} is written into the display element 10 is controlled in a preferred manner. Accordingly, the power consumption by the source amplifier can be reduced in a structure that maintains a fixed bias level, regardless of the value of a gradation signal DTᵢₙ.

### Third Embodiment

The third embodiment also relates to a display device, a method of driving the display device, and a signal output circuit according to the present disclosure.

Generally, a display device displays an image based on data transmitted from outside. A signal output circuit of the third embodiment includes a differential reception unit that receives data transmitted from an external timing controller, and is designed to generate a gradation signal based on the received data. The conductive/non-conductive state of the power supply path of the differential amplifier in the differential reception unit is controlled based on a signal indicating whether the external timing controller is transmitting data that contributes to image display.

More specifically, the power supply path of the differential amplifier is in a conductive state when the external timing controller is transmitting data that contributes to image display, and is in a non-conductive state when the external timing controller is transmitting no data that contributes to image display. With this, power consumption by the differential reception unit can be reduced.

A schematic diagram of a display device 3 according to the third embodiment should be the same as that in FIG. 1, except that the image display unit 1 is replaced with an image display unit 3, and the signal output circuit 120 is replaced with a signal output circuit 320.

The components other than the signal output circuit 320 in the display device 3 are the same as the corresponding components in the display device 1 of the first embodiment. Explanation of them is not made herein. The part of the signal output circuit that contributes to driving of the nth data line may have the structure of the first embodiment described above with reference to FIG. 2, or may have the structure of the second embodiment described above with reference to FIG. 8. Therefore, explanation of driving of the nth data line is not provided herein.

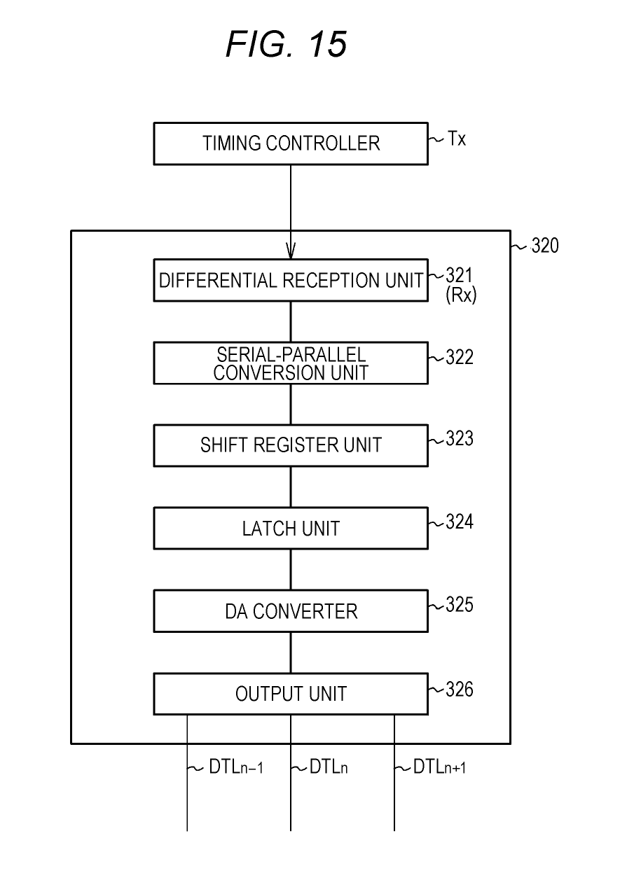

FIG. 15 is a schematic block diagram for explaining the structure of the signal output circuit according to the third embodiment.

Data is transmitted to the signal output circuit 320 from an external timing controller Tx, for example. The signal output circuit 320 includes: a differential reception unit 321 (also referred to as Rx) that receives data from the external timing controller Tx; a serial-parallel conversion unit 320 that converts a serial signal of the differential reception unit 321 into a parallel signal; a shift register unit 323 to which parallel data from the serial-parallel conversion unit 320 is input; a latch unit 324 that holds a signal from the shift register unit 323; a DA converter 325 that converts the digital data being held by the latch unit; and an output unit 326 that amplifies an output of the DA converter 325 and outputs the amplified result to the data line DTL.

To facilitate understanding, a reference example is now described.

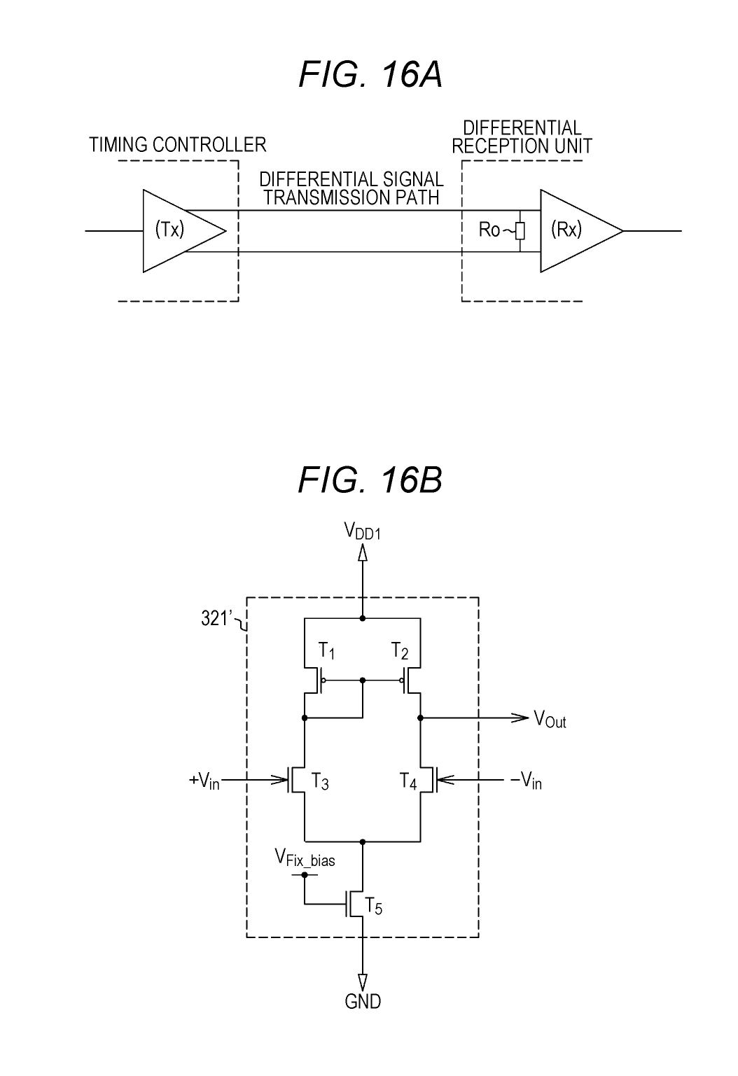

FIG. 16A is a schematic circuit diagram for explaining the connection between the timing controller and a differential reception unit as a reference example. FIG. 16B is a circuit diagram of the differential reception unit as the reference example.

From the timing controller Tx to a differential reception unit 321′ as the reference example, data is transmitted through differential signal transmission paths. Ro represents a terminating resistor.

As shown in FIG. 16B, the differential reception unit 321′ includes a transistor that is a field effect transistor (FET), for example. In FIG. 16B, the gain stage in the differential reception unit 321′ is not shown. The differential reception unit 321′ is formed with a current mirror circuit that includes p-channel transistors T₁ and T₂ and n-channel transistors T₃ and T₄, and signals from the differential signal transmission paths are applied to the gates of the transistors T₃ and T₄. A transistor T₅ is the transistor that sets a bias current. The bias current needs to be increased as the differential reception unit 321′ is operated at a higher speed, and the power consumption associated with the bias current also increases.

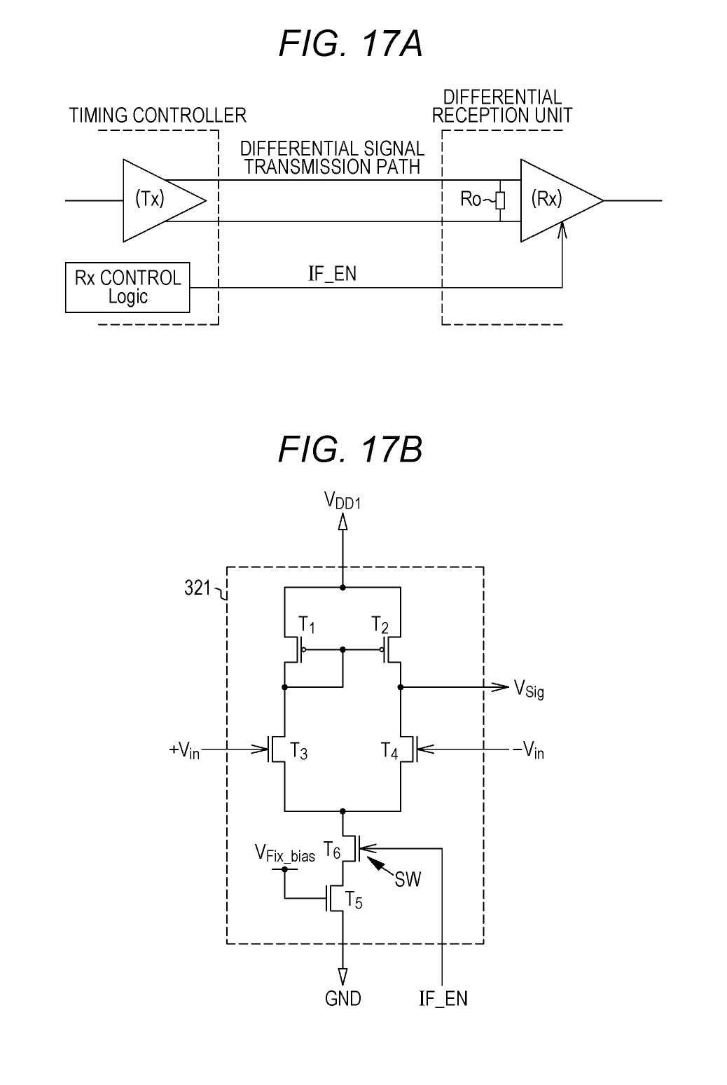

FIG. 17A is a schematic circuit diagram for explaining the connection between the timing controller and the differential reception unit according to the third embodiment. FIG. 17B is a circuit diagram of the differential reception unit according to the third embodiment.

When data that contributes to image display is being transmitted from the timing controller Tx, the differential reception unit needs to operate properly. However, if the differential reception unit remains in an operation state when any effective data is not being transmitted from the timing controller Tx, electric power is wasted.

Therefore, the timing controller Tx transmits a signal IF_EN indicating whether the timing controller Tx is transmitting data that contributes to image display, to the differential reception unit, as shown in FIG. 17A.

As shown in FIG. 17B, in the differential reception unit 321 according to the third embodiment, a transistor T₆ is connected in series to the power supply path to the differential amplifier, and the signal IF_EN is input to the gate of the transistor T₆. When data that contributes to image display is being transmitted from the timing controller Tx, the transistor T₆ is in a conductive state. In any other cases, the transistor T₆ is in a non-conductive state. With this, power consumption at the differential reception unit 321 can be reduced.

The structure of the differential reception unit 321 shown in FIG. 17B is merely an example. Alternatively, the differential reception unit 321 may have a structure like the differential amplifier stage denoted by 124A in FIG. 4, for example.

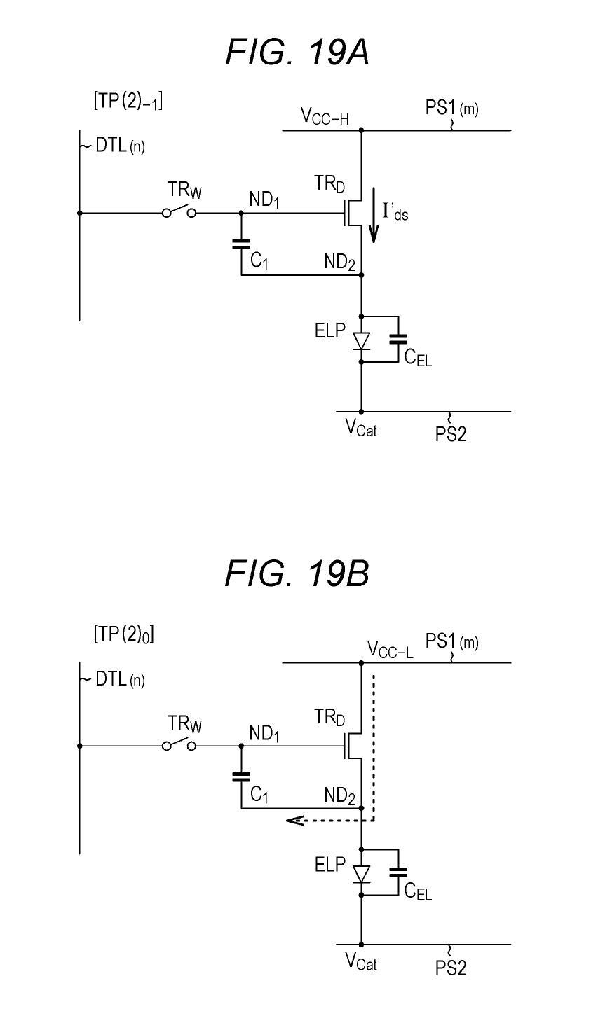

The operation of the signal output circuit 320 has been described in detail. Referring now to FIG. 18, FIGS. 19A and 19B, FIGS. 20A and 20B, FIGS. 21A and 21B, FIGS. 22A and 22B, FIGS. 23A and 23B, and FIG. 24, the operation of an entire display device that is the same among the first through third embodiments is described in detail. Since application of a precharge voltage to a data line DTL does not affect any operation of the display elements 10, the application of a precharge voltage to a data line DTL is not described herein, for ease of explanation.

[Period TP(2)₋₁] (See FIGS. 18 and 19A)

This [period TP(2)₋₁] is an operating period in the previous display frame and the period during which the (n, m)th display element 10 is in a light emitting state after various kinds of processes in the previous period have been completed. That is, a drain current I_{ds}′ based on the equation (5′) shown later flows into the light emitting unit ELP in the display element 10 forming the (n, m)th pixel, and the luminance of the display element 10 forming the (n, m)th pixel has the value corresponding to the drain current I_{ds}′. Here, the write transistor TR_{W} is in a non-conductive state, and the drive transistor TR_{D} is in a conductive state. The light emitting state of the (n, m)th display element 10 continues until immediately before the start of the horizontal scanning period for the display elements 10 arranged in the (m+m′)th ROW.

As described above, for each horizontal scanning period, the reference voltage V_{Ofs} and the video signal voltage V_{Sig} are supplied to the data line DTIₙ. However, since the write transistor TR_{W} is in a non-conductive state, the potentials of the first node ND₁ and the second node ND₂ do not change (potential changes due to electrostatic coupling of parasitic capacitances or the like might occur in practice, but such changes can be ignored normally) even if the potential (voltage) of the data line DTLₙ changes during [period TP(2)₋₁]. The same applies to [period TP(2)₀], which will be described later.

[Period TP(2)₀] through [period TP(2)₆] shown in FIG. 18 are the operating period from the end of the light emitting state after the various kinds of processes in the previous period have been completed until immediately before the next writing process. In principle, in [period TP(2)₀] through [period TP(2)₇] the (n, m)th display element 10 is in a no-light emitting state. As shown in FIG. 18, [period TP(2)₅], [period TP(2)₆] and [period TP(2)₇] are included in the mth horizontal scanning period Hₘ.

Further, in [period TP(2)₃] and [period TP(2)₅], while the reference voltage V_{Ofs} is applied from the data line DTLₙ to the gate electrode of the drive transistor TR_{D} via the write transistor TR_{W} that has been put into a conductive state based on a scanning signal from the scanning line SCL, a drive voltage V_{CC-H} from the power supply line PS1 is applied to one source/drain region of the drive transistor TR_{D}, and the potential of the other source/drain region of the drive transistor TR_{D} is made closer to the potential calculated by subtracting the threshold voltage of the drive transistor TR_{D} from the reference voltage V_{Ofs}. In this manner, a threshold voltage canceling process is performed.

In the description below, the threshold voltage canceling process is performed in horizontal scanning periods, or more specifically, in the (m−1)th horizontal scanning period Hₘ₋₁ and the mth horizontal scanning period Hₘ, but may be performed in other periods.

In [period TP(2)₁], an initializing voltage V_{CC-L}, whose difference from the reference voltage V_{Ofs} exceeds the threshold voltage of the drive transistor TR_{D}, is applied from the power supply line PS1 to the one source/drain region of the drive transistor TR_{D}, and the reference voltage V_{Ofs} is applied from the data line DTLₙ to the gate electrode of the drive transistor TR_{D} via the write transistor TR_{W} that has been put into a conductive state based on a scanning signal from the scanning line SCLₘ. In this manner, the potential of the gate electrode of the drive transistor TR_{D} and the potential of the other source/drain region of the drive transistor TR_{D} are initialized.

In FIG. 18, [period TP(2)₁] corresponds to the reference voltage period (the period during which the reference voltage V_{Ofs} is applied to the data line DTL) in the (m−2)th horizontal scanning period Hₘ₋₂, [period TP(2)₃] corresponds to the reference voltage period in the (m−1)th horizontal scanning period Hₘ₋₁, and [period TP(2)₅] corresponds to the reference voltage period in the mth horizontal scanning period Hₘ.

Referring to FIG. 18 and others, operations in the respective periods of [period TP(2)₀] through [period TP(2)₈] are described.

[Period TP(2)₀] (See FIGS. 18 and 19B)

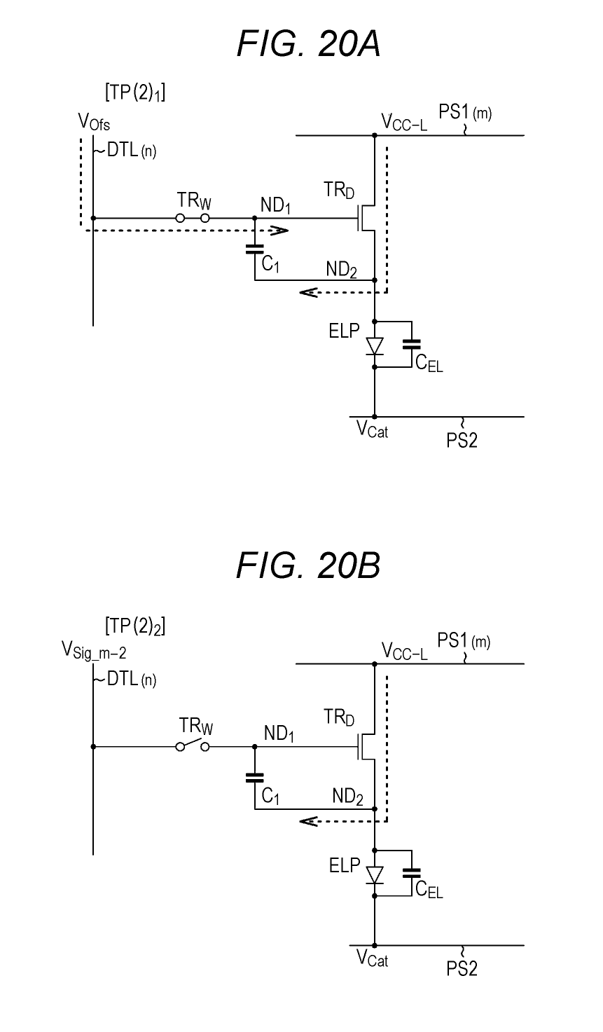

This [period TP (2)₀] is the operating period continuing from the previous display frame to the current display frame. That is, this [period TP(2)₀] is the period from the start of the (m+m′)th horizontal scanning period H_{m+m′} in the previous display frame to the end of the (m−3)th horizontal scanning period in the current display frame. In principle, during this [period TP(2)₀], the (n, m)th display element 10 is in a no-light emitting state. At the start of [period TP(2)₀], the voltage to be supplied from the power supply unit 100 to the power supply line PS1ₘ is switched from the drive voltage V_{CC-H} to the initializing voltage V_{CC-L}. As a result, the potential of the second node ND₂ drops to V_{CC-L}, a reverse voltage is applied between the anode electrode and the cathode electrode of the light emitting unit ELP, and the light emitting unit ELP is put into a no-light emitting state. As if following the drop in the potential of the second node ND₂, the potential of the first node ND₁ (the gate electrode of the drive transistor TR_{D}) in a floating state also drops.

[Period TP(2)₁] (See FIGS. 18 and 20A)

The (m−2)th horizontal scanning period Hₘ₋₂ in the current display frame then starts. In this [period TP(2)₁], the scanning line SCLₘ is set at high level, so that the write transistor TR_{W} of the display element 10 is put into a conductive state. The voltage to be supplied from the signal output circuit 220 to the data line DTLₙ is the reference voltage V_{Ofs}. As a result, the potential of the first node ND₁ becomes V_{Ofs} (0 volts). Since the initializing voltage V_{CC-L} is applied from the power supply line PS1ₘ to the second node ND₂ based on operation of the power supply unit 100, the potential of the second node ND₂ is maintained at V_{CC-L} (−10 volts).

Since the potential difference between the first node ND₁ and the second node ND₂ is 10 volts, and the threshold voltage Vₜₕ of the drive transistor TR_{D} is 3 volts, the drive transistor TR_{D} is in a conductive state. The potential difference between the second node ND₂ and the cathode electrode in the light emitting unit ELP is −10 volts, and does not exceed the threshold voltage V_{th-EL} of the light emitting unit ELP. Accordingly, the potential of the first node ND₁ and the potential of the second node ND₂ are initialized.

[Period TP(2)₂] (See FIGS. 18 and 20B)

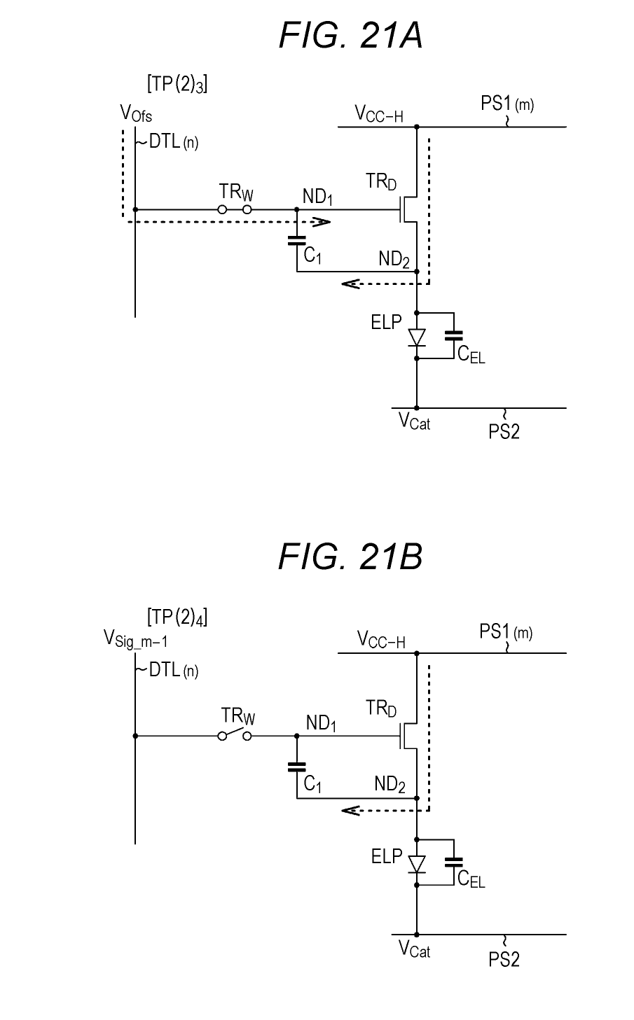

In this [period TP(2)₂], the scanning line SCLₘ is set at low level. The write transistor TR_{W} of the display element 10 is put into a non-conductive state. The potentials of the first node ND₁ and the second node ND₂ basically remain the same as in the previous period.

[Period TP(2)₃] (See FIGS. 18 and 21A)

In this [period TP(2)₃], the first threshold voltage canceling process is performed. The scanning line SCLₘ is set at high level, so that the write transistor TR_{W} of the display element 10 is put into a conductive state. The voltage to be supplied from the signal output circuit 220 to the data line DTLₙ is the reference voltage V_{Ofs}. The potential of the first node ND₁ is V_{Ofs} (0 volts).

The voltage to be supplied from the power supply unit 100 to the power supply line PS1ₘ is then switched from the voltage V_{CC-L} to the drive voltage V_{CC-H}. As a result, the potential of the first node ND₁ does not change (or remains at V_{Ofs}=0 volts), but the potential of the second node ND₂ changes toward the potential calculated by subtracting the threshold voltage Vₜₕ of the drive transistor TR_{D} from the reference voltage V_{Ofs}. That is, the potential of the second node ND₂ becomes higher.

If this [period TP(2)₃] is long enough, the potential difference between the gate electrode and the other source/drain region of the drive transistor TR_{D} reaches Vₜₕ, and the drive transistor TR_{D} enters a non-conductive state. That is, the potential of the second node ND₂ approaches (V_{Ofs}−Vₜₕ), and eventually becomes (V_{Ofs}−Vₜₕ). In the example shown in FIG. 18, however, the duration of [period TP(2)₃] is not long enough to change the potential of the second node ND₂, and, at the end of [period TP(2)₃], the potential of the second node ND₂ reaches a potential V₁, which satisfies the relationship, V_{CC-L}<V₁<(V_{Ofs}−Vₜₕ).

[Period TP(2)₄] (See FIGS. 18 and 21B)

In this [period TP(2)₄], the scanning line SCLₘ is set at low level, so that the write transistor TR_{W} of the display element 10 is put into a non-conductive state. As a result, the first node ND₁ is put into a floating state.

Since the drive voltage V_{CC-H} is applied from the power supply unit 100 to the one source/drain region of the drive transistor TR_{D}, the potential of the second node ND₂ increases from the potential V₁ to a potential V₂. Meanwhile, the gate electrode of the drive transistor TR_{D} is in a floating state, and the capacitance unit C₁ exists. Because of this, a bootstrapping occurs in the gate electrode of the drive transistor TR_{D}. Therefore, the potential of the first node ND₁ increases, following the change in the potential of the second node ND₂.

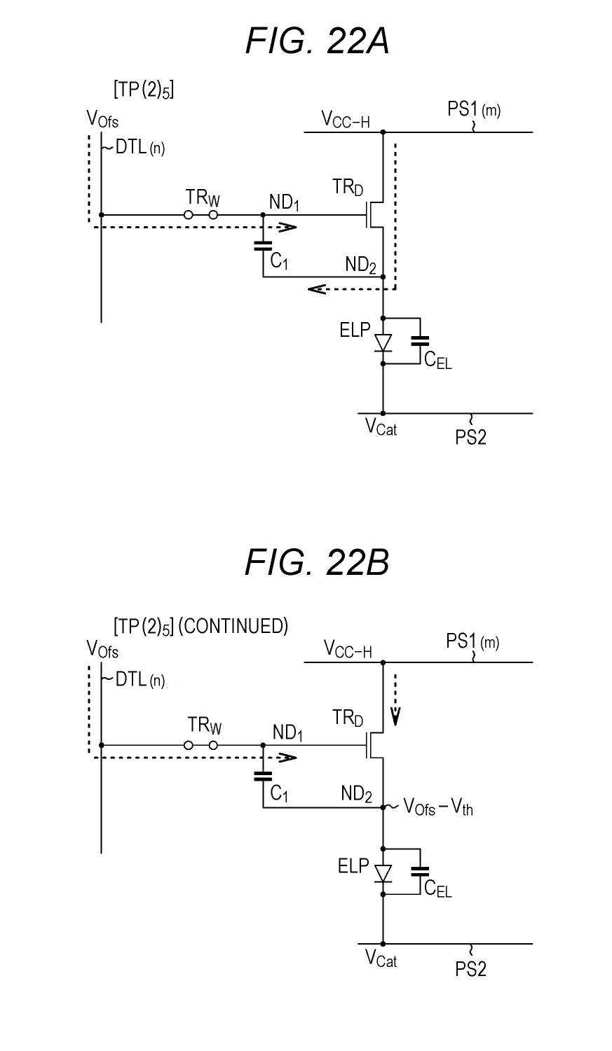

As a precondition for the operation in the next [period TP(2)₅], the potential of the second node ND₂ needs to be lower than (V_{Ofs}−Vₜₕ) at the start of [period TP(2)₅]. The duration of [period TP(2)₄] is basically determined so as to satisfy the condition, V₂<(V_{Ofs-L}−Vₜₕ).

[Period TP(2)₅] (See FIGS. 18, 22A, and 22B)

In this [period TP(2)₅], the second threshold voltage canceling process is performed. The write transistor TR_{W} of the display element 10 is put into a conductive state based on a scanning signal from the scanning line SCLₘ. The voltage to be supplied from the signal output circuit 220 to the data line DTLₙ is the reference voltage V_{Ofs}. The potential of the first node ND₁ changes from the potential increased by the bootstrapping, and returns to V_{Ofs} (0 volts) (see FIG. 22A).

Here, the value of the capacitance unit C₁ is a value c₁, and the value of the capacitance C_{EL} of the light emitting unit ELP is a value c_{EL}. The value of the parasitic capacitance between the gate electrode and the other source/drain region of the drive transistor TR_{D} is represented by c_{gs}. Where the capacitance value between the first node ND₁ and the second node ND₂ is represented by c_{A}, c_{A}=c₁+c_{gs}. Where the capacitance value between the second node ND₂ and the second power supply line PS2 is represented by c_{B}, c_{B}=c_{EL}. Additional capacitance units may be connected in parallel to both ends of the light emitting unit ELP. In that case, however, the capacitance values of the additional capacitance units are further added to C_{B}.

When the potential of the first node ND₁ changes, the potential between the first node ND₁ and the second node ND₂ also changes. That is, the charge based on the change in the potential of the first node ND₁ is divided in accordance with the capacitance value between the first node ND₁ and the second node ND₂, and the capacitance value between the second node ND₂ and the second power supply line PS2. Accordingly, if the value c_{b} (=c_{EL}) is sufficiently larger than the value c_{A} (=c₁+c_{gs}), the change in the potential of the second node ND₂ is small. The value c_{EL} of the capacitance C_{EL} of the light emitting unit ELP is normally larger than the value c₁ of the capacitance unit C₁ and the value c_{gs} of the parasitic capacitance of the drive transistor TR_{D}. In the description below, changes in the potential of the second node ND₂ caused by changes in the potential of the first node ND₁ are not taken into account. In the drive timing chart shown in FIG. 18, changes in the potential of the second node ND₂ caused by changes in the potential of the first node ND₁ are not taken into account.

Since the drive voltage V_{CC-H} is applied from the power supply unit 100 to the one source/drain region of the drive transistor TR_{D}, the potential of the second node ND₂ changes toward the potential calculated by subtracting the threshold voltage Vₜₕ of the drive transistor TR_{D} from the reference voltage V_{Ofs}. That is, the potential of the second node ND₂ increases from the potential V₂, and changes toward the potential calculated by subtracting the threshold voltage Vₜₕ of the drive transistor TR_{D} from the reference voltage V_{Ofs}. When the potential difference between the gate electrode and the other source/drain region of the drive transistor TR_{D} reaches Vₜₕ, the drive transistor TR_{D} enters a non-conductive state (see FIG. 22B). In this state, the potential of the second node ND₂ is approximately (V_{Ofs}−Vₜₕ). As long as the equation (3) shown below is satisfied, or potentials are selected and determined so as to satisfy the equation (3), the light emitting unit ELP emits no light.

(V_{Ofs}−Vₜₕ)<(V_{th-EL}+V_{Cat}) (3)

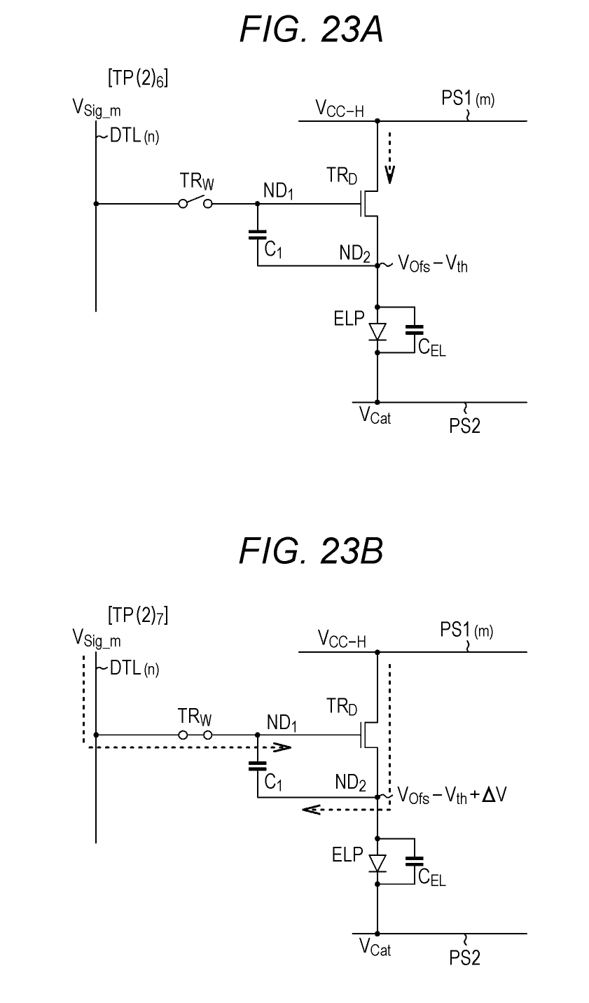

In this [period TP(2)₅], the potential of the second node ND₂ eventually becomes (V_{Ofs}−Vₜₕ). That is, the potential of the second node ND₂ is determined depending only on the threshold voltage Vₜₕ of the drive transistor TR_{D} and the reference voltage V_{Ofs}. The potential of the second node ND₂ is independent of the threshold voltage V_{th-EL} of the light emitting unit ELP. At the end of [period TP(2)₅], the write transistor TR_{W} is put into a non-conductive state from a conductive state based on a scanning signal from the scanning line SCLₘ.

[Period TP(2)₆] (See FIGS. 18 and 23A)

While the write transistor TR_{W} is maintained in a non-conductive state, the video signal voltage V_{Sig}_{_{—}}ₘ, instead of the reference voltage V_{Ofs}, is supplied from the signal output circuit 220 to one end of the data line DTLₙ. If the drive transistor TR_{D} has entered a non-conductive state during [period TP(2)₅], the potentials of the first node ND₁ and the second node ND₂ do not change (potential changes due to electrostatic coupling of parasitic capacitances or the like might occur in practice, but such changes can be ignored normally) In a case where the drive transistor TR_{D} has not entered a non-conductive state through the threshold voltage canceling process performed in [period TP(2)₅], bootstrapping occurs in [period TP(2)₆], and the potentials of the first node ND₁ and the second node ND₂ become slightly higher.

[Period TP(2)₇] (See FIGS. 18 and 23B)

In this [period TP(2)₇], the write transistor TR_{W} of the display element 10 is put into a conductive state based on a scanning signal from the scanning line SCLₘ. The video signal voltage V_{Sig}_{_{—}}ₘ is applied from the data line DTLₙ to the gate electrode of the write transistor TR_{W}.

In the above described writing process, the video signal voltage V_{Sig} is applied to the gate electrode of the drive transistor TR_{D} while the drive voltage V_{CC-H} is applied from the power supply unit 100 to the one source/drain region of the drive transistor TR_{D}. Therefore, in the display element 10, the potential of the second node ND₂ changes in [period TP(2)₇], as shown in FIG. 18. Specifically, the potential of the second node ND₂ becomes higher. This increase in the potential is represented by ΔV.

Where the potential of the gate electrode (the first node ND₁) of the drive transistor TR_{D} is represented by V_{g}, and the potential of the other source/drain region (the second node ND₂) of the drive transistor TR_{D} is represented by Vₛ, the value of V_{g} and the value of Vₛ are as described below, as long as the above mentioned increase in the potential of the second node ND₂ is not taken into account. The potential difference between the first node ND₁ and the second node ND₂, or the potential difference V_{gs} between the gate electrode and the other source/drain region serving as the source region of the drive transistor TR_{D}, can be expressed by the equation (4) shown below.

V_{g}=V_{Sig}_{_{—}}ₘ

Vₛ≈V_{Ofs}−Vₜₕ

V_{gs}≈V_{Sig}_{_{—}}ₘ−(V_{Ofs}−Vₜₕ) (4)

That is, V_{gs} obtained through the writing process performed on the drive transistor TR_{D} depends only on the video signal voltage V_{Sig}_{_{—}}ₘ for controlling luminance in the light emitting unit ELP, the threshold voltage Vₜₕ of the drive transistor TR_{D}, and the reference voltage V_{Ofs}. It should be noted that V_{gs} is independent of the threshold voltage V_{th-EL} of the light emitting unit ELP.

Next, the above mentioned increase (ΔV) in the potential of the second node ND₂ is described. By the above described drive method, a writing process is performed, with the drive voltage V_{CC-H} being applied to the one source/drain region of each drive transistor TR_{D} of the display element 10. With this, a mobility correcting process is also performed to change the potential of the other source/drain region of each drive transistor TR_{D} of the display element 10.

In a case where the drive transistors TR_{D} are formed with thin-film transistors or the like, mobility μ inevitably varies among the transistors. Even if video signal voltages V_{Sig} of the same value are applied to the gate electrodes of drive transistors TR_{D} that differ from one another in the mobility μ, a difference is caused between the drain current I_{ds} flowing in a drive transistor TR_{D} having a high mobility μ and the drain current I_{ds} flowing in a drive transistor TR_{D} having a low mobility μ. If such a difference is caused, the screen of the display device 1 cannot maintain uniformity.

By the above described drive method, the video signal voltage V_{Sig} is applied to the gate electrode of each drive transistor TR_{D} while the drive voltage V_{CC-H} is applied from the power supply unit 100 to the one source/drain region of each drive transistor TR_{D}. Therefore, the potential of the second node ND₂ becomes higher in the writing process, as shown in FIG. 18. In a case where the value of the mobility μ of the drive transistor TR_{D} is large, the increase ΔV (potential correction value) in the potential in the other source/drain region (or the potential of the second node ND₂) of the drive transistor TR_{D} is large. In a case where the value of the mobility μ of the drive transistor TR_{D} is small, on the other hand, the increase ΔV in the potential in the other source/drain region of the drive transistor TR_{D} is small. Here, the potential difference V_{gs} between the gate electrode and the other source/drain region serving as the source region of the drive transistor TR_{D} is transformed from equation (4) to the equation (5) shown below.

V_{gs}≈V_{Sig}_{_{—}}ₘ−(V_{Ofs}−Vₜₕ)−ΔV (5)

The duration of the period of the scanning signal for writing the video signal voltage V_{Sig} should be determined in accordance with the designs of the display element 10 and the display device 1. Also, the duration of the period of the scanning signal is determined so that the potential (V_{Ofs}−Vₜₕ ΔV) in the other source/drain region of the drive transistor TR_{D} satisfies the equation (3′) shown below.

In the display element 10, the light emitting unit ELP does not emit light during [period TP(2)₇]. Through this mobility correcting process, the variation in a coefficient k(≡(1/2)·(W/L)·Cₒₓ) is also corrected at the same time.

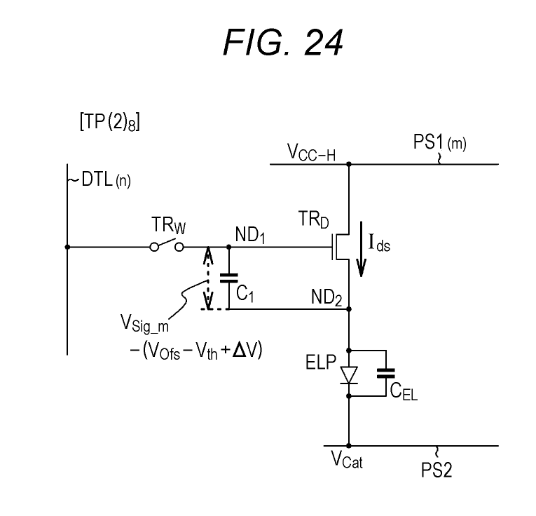

(V_{Ofs}−Vₜₕ+ΔV)<(V_{th-EL}+V_{Cat}) (3′)

[Period TP(2)₈] (See FIGS. 18 and 24)

The state where the drive voltage V_{CC-H} is applied from the power supply unit 100 to the one source/drain region of the drive transistor TR_{D} is maintained. In the display element 10, the capacitance unit C₁ holds the voltage in accordance with the video signal voltage V_{Sig m} through the writing process. Since the supply of the scanning signal from the scanning line has ended, the write transistor TR_{W} is in a non-conductive state. Therefore, the application of the video signal voltage V_{Sig}_{_{—}}ₘ to the gate electrode of the drive transistor TR_{D} is stopped. Accordingly, a current that corresponds to the value of the voltage being held in the capacitance unit C₁ through the writing process is applied to the light emitting unit ELP via the drive transistor TR_{D}, and the light emitting unit ELP emits light.

The operation of the display element 10 is now described in greater detail. A state where the drive voltage V_{CC-H} is applied from the power supply unit 100 to the one source/drain region of the drive transistor TR_{D} is maintained, and the first node ND₁ is electrically disconnected from the data line DTLₙ. As a result of the above, the potential of the second node ND₂ increases accordingly.

Here, the gate electrode of the drive transistor TR_{D} is in a floating state as described above. Furthermore, since there is the capacitance unit C₁, the same phenomenon as that in a so-called bootstrap circuit occurs in the gate electrode of the drive transistor TR_{D}, and the potential of the first node ND₁ also increases. As a result, the potential difference V_{gs} between the gate electrode and the other source/drain region serving as the source region of the drive transistor TR_{D} has the value according to the equation (5).

As the potential of the second node ND₂ increases and exceeds (V_{th-EL}+V_{Cat}), the light emitting unit ELP starts emitting light. The current that flows in the light emitting unit ELP in this case is a drain current I_{ds} flowing from the drain region to the source region of the drive transistor TR_{D}, and therefore, can be expressed by the equation (1). Here, the equation (1) can be transformed into the equation (6) shown below based on the equations (1) and (5).

I_{ds}=k·μ·(V_{Sig}_{_{—}}ₘ−V_{Ofs}−ΔV)² (6)

Accordingly, in a case where the reference voltage V_{Ofs} is set at 0 volts, the current I_{ds} flowing in the light emitting unit ELP is proportional to the square of the value calculated by subtracting the value of the potential correction value ΔV derived from the motility μof the drive transistor TR_{D}, from the value of the video signal voltage V_{Sig}_{_{—}}ₘ for controlling luminance in the light emitting unit ELP. In other words, the current I_{ds} flowing in the light emitting unit ELP does not depend on the threshold voltage V_{th-EL} of the light emitting unit ELP and the threshold voltage Vₜₕ of the drive transistor TR_{D}. That is, the amount of luminescence (luminance) of the light emitting unit ELP is not affected by the threshold voltage V_{th-EL} of the light emitting unit ELP and the threshold voltage Vₜₕ of the drive transistor TR_{D}. The luminance of the display element 10 forming the (n, m)th pixel is the value corresponding to such a current I_{ds}.

As a drive transistor TR_{D} with a higher mobility μ has a greater potential correction value ΔV, the value of V_{gs} in the left-hand side of the equation (5) becomes smaller. Therefore, even when the value of the mobility μ is large, the value of (V_{Sig}_{_{—}}ₘ−V_{Ofs}−ΔV)² becomes smaller in the equation (6). As a result, the variation in the drain current I_{ds} due to a variation in the mobility μ of the drive transistor TR_{D} (as well as a variation in k) can be corrected. In this manner, the variation in the luminance of the light emitting unit ELP due to a variation in the mobility μ (as well as a variation in k) can be corrected.

The light emitting state of the light emitting unit ELP continues until the (m+m′−1)th horizontal scanning period. The end of the (m+m′−1)th horizontal scanning period corresponds to the end of [period TP(2)₋₁]. Here, “m′” satisfies the relationship, 1<m′<M, and is a predetermined value in the display device 1. In other words, the light emitting unit ELP is driven from the start of [period TP(2)₈] until immediately before the (m+m′)th horizontal scanning period H_{m+m′}, and this period is a light emitting period.

Although embodiments of the present disclosure have been specifically described so far, the present disclosure is not limited to the above embodiments, and various changes based on the technical idea of the present disclosure can be made to them. For example, the numerical values, structures, substrates, materials, processes, and the like, which have been described in the above embodiments, are merely examples, and different numerical values, structures, substrates, materials, processes, and the like from the above may be used where necessary.

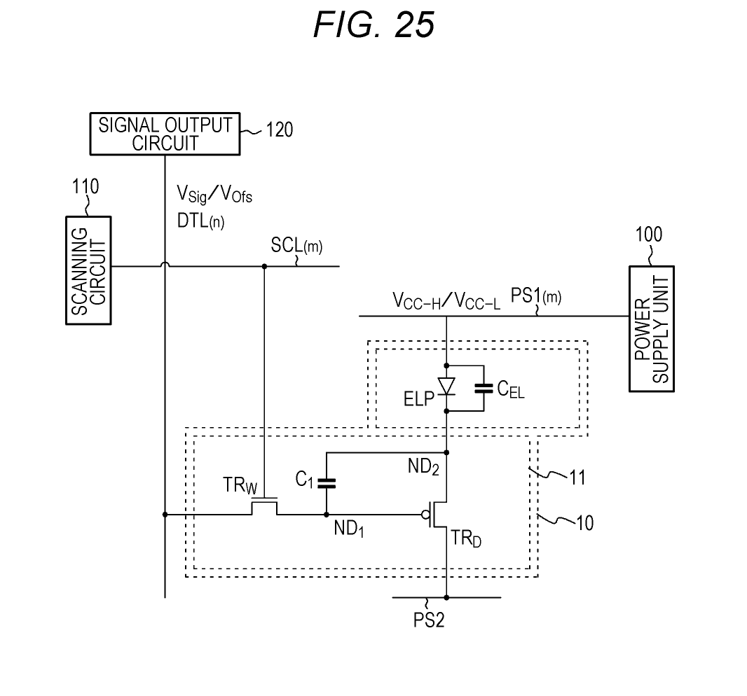

In a case where each drive transistor is a p-channel transistor, for example, the wiring relationship between the drive transistor and the light emitting unit ELP should be reversed as shown in FIG. 25. In this circuit, threshold voltage canceling processes, writing processes, and bootstrapping can also be performed without any problem.

The present disclosure can also be in the following forms.

[1] A display device including:

a display unit that includes display elements arranged in a two-dimensional matrix fashion, the display elements each including a light emitting unit of a current drive type and a drive circuit that drives the light emitting unit, the display elements being connected to a scanning line extending in a row direction and a data line extending in a column direction; and

a signal output circuit that alternately supplies a reference voltage and a video signal voltage to the data line,

wherein the signal output circuit includes:

an output node to which the data line is connected;

a reference voltage node to which the reference voltage is applied;

a source amplifier that outputs the video signal voltage in accordance with an input gradation signal;

a first switch provided between an output side of the source amplifier and the output node;

a second switch provided between the reference voltage node and the output node; and

a third switch provided in a power supply path of the source amplifier,

during a scanning period for scanning the display elements row by row, switching is performed between a state where the first switch is non-conductive while the second switch is conductive and a state where the first switch is conductive while the second switch is non-conductive, and

the third switch is put into a conductive state when the first switch is put into a conductive state, and is put into a non-conductive state when the first switch is put into a non-conductive state.

[2] The display device of [1], wherein

the signal output circuit further includes:

a power supply voltage node to which a predetermined power supply voltage is applied; and

a fourth switch provided between the power supply voltage node and the output node, and

during the scanning period for scanning the display elements row by row, the fourth switch is put into in a conductive state while the first switch and the second switch are in a non-conductive state, between the state where the first switch is non-conductive while the second switch is conductive and the state where the first switch is conductive while the second switch is non-conductive.

[3] The display device of [3], wherein the signal output circuit further includes a precharge control circuit that controls a value of a precharge voltage to be applied to the data line connected to the output node, by controlling a duration of time during which the fourth switch is in a conductive state.

[4] The display device of [3], wherein, based on a value of the gradation signal, the precharge control circuit controls the duration of time during which the fourth switch is in a conductive state.

[5] The display device of any of [1] through [4], wherein the signal output circuit further includes a bias control circuit that controls a value of a bias current of the source amplifier based on a value of the gradation signal.

[6] The display device of [5], wherein the bias control circuit controls the value of the bias current of the source amplifier based on the value of the gradation signal.

[7] The display device of any of [1] through [6], wherein

the signal output circuit includes a differential reception unit that receives data transmitted from an external timing controller, and is designed to generate the gradation signal based on the received data, and

a conductive/non-conductive state of a power supply path of a differential amplifier in the differential reception unit is controlled based on a signal indicating whether the external timing controller is transmitting data that contributes to image display.

[8] A signal output circuit that is used to alternately supply a reference voltage and a video signal voltage to a data line of a display unit including display elements arranged in a two-dimensional matrix fashion, the display elements each including a light emitting unit of a current drive type and a drive circuit that drives the light emitting unit, the display elements being connected to a scanning line extending in a row direction and the data line extending in a column direction,

the signal output circuit including:

an output node to which the data line is connected;

a reference voltage node to which the reference voltage is applied;

a source amplifier that outputs the video signal voltage in accordance with an input gradation signal;

a first switch provided between an output side of the source amplifier and the output node;

a second switch provided between the reference voltage node and the output node; and

a third switch provided in a power supply path of the source amplifier,

wherein, during a scanning period for scanning the display elements row by row, switching is performed between a state where the first switch is conductive while the second switch is non-conductive and a state where the second switch is non-conductive while the second switch is conductive, and

the third switch is put into a conductive state when the first switch is put into a conductive state, and is put into a non-conductive state when the first switch is put into a non-conductive state.

[9] A method of driving a display device that includes:

a display unit including display elements arranged in a two-dimensional matrix fashion, the display elements each including a light emitting unit of a current drive type and a drive circuit that drives the light emitting unit, the display elements being connected to a scanning line extending in a row direction and a data line extending in a column direction; and

a signal output circuit that alternately supplies a reference voltage and a video signal voltage to the data line,

the signal output circuit including:

an output node to which the data line is connected;

a reference voltage node to which the reference voltage is applied;

a source amplifier that outputs the video signal voltage in accordance with an input gradation signal;

a first switch provided between an output side of the source amplifier and the output node;

a second switch provided between the reference voltage node and the output node; and

a third switch provided in a power supply path of the source amplifier,

the method including:

during a scanning period for scanning the display elements row by row, performing switching between a state where the first switch is conductive while the second switch is non-conductive and a state where the second switch is non-conductive while the second switch is conductive, and

putting the third switch into a conductive state when the first switch is put into a conductive state, and putting the third switch into a non-conductive state when the first switch is put into a non-conductive state.

### REFERENCE SIGNS LIST

1, 2, 3 Display device
10 Display element
11 Drive circuit
20 Display unit
21 Support
22 Substrate
31 Gate electrode
32 Gate insulating layer
33 Semiconductor layer
34 Channel forming region
35, 35 Source/drain region
36 The other electrode
37 One electrode
38, 39 Interconnect
40 Interlayer insulating film
51 Anode electrode
52 Hole transport layer, light emitting layer, and electron transport layer
53 Cathode electrode
54 Second interlayer insulating film
55, 56 Contact hole
100 Power supply unit
110 Scanning circuit
120, 220, 320 Signal output circuit
121 Gradation signal input unit
122A, 122B, 222C Power supply terminal
123 DA converter
124, 224 Source amplifier
124A, 224A Differential amplifier stage
124B, 224B Gain stage
125, 225 Switch control circuit
126 Output terminal
227 Precharge control circuit
228 Bias control circuit
321, 321′ Differential reception unit
322 Serial-parallel conversion unit
323 Shift register unit
324 Latch unit
325 DA converter
326 Output unit
TR_{W} Write transistor
TR_{D} Drive transistor
C₁ Capacitance unit
ELP Organic electroluminescence light emitting unit
C_{EL} Capacitance of light emitting unit ELP
ND₁ First node
ND₂ Second node
SCL Scanning line
DTL Data line
PS1 Power supply line
PS2 Second power supply line
Q₁₁ to Q₁₈, Q₂₁ to Q₂₈, Q₃₁ to Q₃₉, T₁ to T₆ Transistor (FET)
C_{G} Capacitor
SW1 First switch
SW2 Second switch
SW3(SW3₁,SW3₂) Third switch
SW4 Fourth switch

1. A display device comprising:
a display unit including display elements arranged in a two-dimensional matrix fashion, the display elements each including a light emitting unit of a current drive type and a drive circuit configured to drive the light emitting unit, the display elements being connected to a scanning line extending in a row direction and a data line extending in a column direction; and
a signal output circuit configured to alternately supply a reference voltage and a video signal voltage to the data line,
wherein the signal output circuit includes:
an output node to which the data line is connected;
a reference voltage node to which the reference voltage is applied;
a source amplifier configured to output the video signal voltage in accordance with an input gradation signal;
a first switch provided between an output side of the source amplifier and the output node;
a second switch provided between the reference voltage node and the output node; and
a third switch provided in a power supply path of the source amplifier,
during a scanning period for scanning the display elements row by row, switching is performed between a state where the first switch is non-conductive while the second switch is conductive, and a state where the first switch is conductive while the second switch is non-conductive, and
the third switch is put into a conductive state when the first switch is put into a conductive state, and is put into a non-conductive state when the first switch is put into a non-conductive state.

2. The display device according to claim 1, wherein
the signal output circuit further includes:
a power supply voltage node to which a predetermined power supply voltage is applied; and
a fourth switch provided between the power supply voltage node and the output node, and
during the scanning period for scanning the display elements row by row, the fourth switch is put into in a conductive state while the first switch and the second switch are in a non-conductive state, between the state where the first switch is non-conductive while the second switch is conductive and the state where the first switch is conductive while the second switch is non-conductive.

3. The display device according to claim 2, wherein the signal output circuit further includes a precharge control circuit configured to control a value of a precharge voltage to be applied to the data line connected to the output node, by controlling a duration of time during which the fourth switch is in a conductive state.

4. The display device according to claim 3, wherein, based on a value of the gradation signal, the precharge control circuit controls the duration of time during which the fourth switch is in a conductive state.

5. The display device according to claim 1, wherein the signal output circuit further includes a bias control circuit configured to control a value of a bias current of the source amplifier based on a value of the gradation signal.

6. The display device according to claim 5, wherein the bias control circuit controls a value of the bias current of the source amplifier based on a value of the gradation signal.

7. The display device according to claim 1, wherein
the signal output circuit includes a differential reception unit configured to receive data transmitted from an external timing controller, the signal output circuit being configured to generate the gradation signal based on the received data, and
a conductive/non-conductive state of a power supply path of a differential amplifier in the differential reception unit is controlled based on a signal indicating whether the external timing controller is transmitting data contributing to image display.

8. A signal output circuit that is used to alternately supply a reference voltage and a video signal voltage to a data line of a display unit including display elements arranged in a two-dimensional matrix fashion, the display elements each including a light emitting unit of a current drive type and a drive circuit configured to drive the light emitting unit, the display elements being connected to a scanning line extending in a row direction and the data line extending in a column direction,
the signal output circuit comprising:
an output node to which the data line is connected;
a reference voltage node to which the reference voltage is applied;
a source amplifier configured to output the video signal voltage in accordance with an input gradation signal;
a first switch provided between an output side of the source amplifier and the output node;
a second switch provided between the reference voltage node and the output node; and
a third switch provided in a power supply path of the source amplifier,
wherein, during a scanning period for scanning the display elements row by row, switching is performed between a state where the first switch is conductive while the second switch is non-conductive and a state where the second switch is non-conductive while the second switch is conductive, and
the third switch is put into a conductive state when the first switch is put into a conductive state, and is put into a non-conductive state when the first switch is put into a non-conductive state.

9. A method of driving a display device including:
a display unit including display elements arranged in a two-dimensional matrix fashion, the display elements each including a light emitting unit of a current drive type and a drive circuit configured to drive the light emitting unit, the display elements being connected to a scanning line extending in a row direction and a data line extending in a column direction; and
a signal output circuit configured to alternately supply a reference voltage and a video signal voltage to the data line,
the signal output circuit including:
an output node to which the data line is connected;
a reference voltage node to which the reference voltage is applied;
a source amplifier configured to output the video signal voltage in accordance with an input gradation signal;
a first switch provided between an output side of the source amplifier and the output node;
a second switch provided between the reference voltage node and the output node; and
a third switch provided in a power supply path of the source amplifier,
the method comprising:
during a scanning period for scanning the display elements row by row, performing switching between a state where the first switch is conductive while the second switch is non-conductive and a state where the second switch is non-conductive while the second switch is conductive, and
putting the third switch into a conductive state when the first switch is put into a conductive state, and putting the third switch into a non-conductive state when the first switch is put into a non-conductive state.
